(19) United States
(12) Patent Application Publication
(10) Pub. No.: US 2010/0149476 A1
(43) Pub. Date: Jun. 17, 2010

(54) DISPLAY SUBSTRATE AND METHOD OF MANUFACTURING THE SAME

(75) Inventors: Do-Hyun KIM, Seoul (KR); Jong-Hyun CHOUNG, Hwaseong-si (KR); Young-Joo CHOI, Yeonggwang-gun (KR); Hong-Sick PARK, Suwon-si (KR); Tae-Hyung IHN, Seoul (KR); Dong-Hoon LEE, Seoul (KR); Pil-Sang YUN, Seoul (KR); Je-Hyeong PARK, Hwaseong-si (KR); Chang-Oh JEONG, Suwon-si (KR); Je-Hun LEE, Seoul (KR); Sun-Young HONG, Yongin-si (KR); Bong-Kyun KIM, Incheon (KR); Byeong-Jin LEE, Seoul (KR); Nam-Seok SUH, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/534,300

(22) Filed: Aug. 3, 2009

(30) Foreign Application Priority Data
Dec. 12, 2008 (KR) 2008-126367

(51) Int. Cl. G02F 1/1333; B05D 5/12; B44C 1/22

(52) U.S. Cl. 349/138; 427/66; 216/23; 349/122

(57) ABSTRACT

A display substrate includes; a base substrate, a deformation preventing layer disposed on a lower surface of the base substrate, wherein the deformation preventing layer applies a force to the base substrate to prevent the base substrate from bending, a gate line disposed on an upper surface of the base substrate, a data line disposed on the base substrate, and a pixel electrode disposed on the base substrate.

This application claims priority to Korean Patent Application No. 2008-126367, filed on Dec. 12, 2008, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a display substrate and a method of manufacturing the display substrate. More particularly, exemplary embodiments of the present invention relate to a display substrate capable of preventing defects generated due to a step difference and a method of manufacturing the display substrate.

2. Description of the Related Art

A liquid crystal display (“LCD”) device displays an image by applying a voltage to a liquid crystal layer interposed between two substrates to control a light transmittance through the liquid crystal layer. Here, in order to apply the voltage, the LCD device typically includes an electrode formed on a display substrate and a switching element (e.g., a thin-film transistor (“TFT”) applying a data voltage to the electrode.

As display technologies have developed, increases in display area, higher resolution and faster response speeds have become expected from an LCD device. The achievement of the expectations about the LCD device largely depends on an enhancement of a manufacturing process of the LCD device and also on a selection of a suitable metallic material for forming signal lines of the LCD device.

That is, as the LCD device is developed to have a large size and a high resolution, a resistance of a metallic signal line is increased due to decrease of the metallic signal line's width and an increase in the aperture ratio. Thus, a process development for a metallic signal line having a low resistivity is desired in order to achieve a high resolution and a large scale LCD device.

In order to secure a low resistance, a signal line having a thicker thickness than a conventional signal line may be deposited on a base substrate. However, when a low resistance line material having a thicker thickness is deposited on the base substrate, the base substrate may be bent, e.g., it may become bowed by a tensile stress applied thereto by the signal lines as they cool after deposition thereon.

Therefore, a manufacturing process of the display substrate may be unduly restricted, and defects may be generated on the display substrate.

### BRIEF SUMMARY OF THE INVENTION

Exemplary embodiments of the present invention provide a display substrate capable of preventing bending during a manufacturing process thereof.

Exemplary embodiments of the present invention also provide a method of manufacturing the above-mentioned display substrate.

Exemplary embodiments of the present invention further also provide a method of manufacturing the above-mentioned display substrate capable of preventing defects generated due to a stepped difference during a subsequent process of a patterning process performed to form a gate line of a display substrate.

According to one exemplary embodiment of the present invention, a display substrate includes; a base substrate, a deformation preventing layer disposed on a lower surface of the base substrate, wherein the deformation preventing layer applies a force to the base substrate to prevent the base substrate from bending, a gate line disposed on an upper surface of the base substrate, and a pixel electrode disposed on the base substrate.

In an exemplary embodiment of the present invention, each of the deformation preventing layer and the gate line may have a tensile stress applied thereto. In one exemplary embodiment, the gate line may include at least one selected from the group consisting of aluminum (Al), copper (Cu), silver (Ag), aluminum (Al) alloy, a copper (Cu) alloy, a silver (Ag) alloy and combinations thereof. In one exemplary embodiment, the deformation preventing layer may include at least one of an organic insulation layer or an inorganic insulation layer. In one exemplary embodiment, the deformation preventing layer may include at least one selected from the group consisting of a silicon nitride (SiNx) and a silicon oxide (SiO2), and combinations thereof.

According to another exemplary embodiment of the present invention, a display substrate includes; a base substrate, a deformation preventing layer disposed on an upper surface of the base substrate, wherein the deformation preventing layer applies a force to the base substrate to prevent the base substrate from bending, a gate line disposed on the deformation preventing layer, a data line disposed on the deformation preventing layer, and a pixel electrode disposed on the base substrate.

In an exemplary embodiment of the present invention, the gate line may include a metal material having a tensile stress applied thereto. In one exemplary embodiment, the deformation preventing layer may include a material having a compression stress applied thereto. In one exemplary embodiment, the deformation preventing layer may include an inorganic layer. In one exemplary embodiment, the deformation preventing layer may include at least one selected from the group consisting of silicon nitride (SiNx), titanium nitride (TiNx), molybdenum nitride (MoNx), silicon oxide (SiO2), copper oxide (CuOx), copper nitride (CuNx), indium tin oxide (“ITO”), indium zinc oxide (“IZO”), and combinations thereof. Alternative exemplary embodiments include configurations wherein the deformation preventing layer may include an organic layer.

According to another exemplary embodiment of the present invention, a method of manufacturing a display substrate includes disposing a deformation preventing layer on a lower surface of a base substrate, wherein the deformation preventing layer applies a force to the base substrate to prevent the base substrate from bending, disposing a gate metal layer on an upper surface of the base substrate, patterning the gate metal layer to form a gate line, disposing a data line crossing the gate line on the base substrate, and disposing a pixel electrode on the base substrate.

In an exemplary embodiment of the present invention, each of the deformation preventing layer and the gate line may have a tensile stress applied thereto. In one exemplary embodiment, the deformation preventing layer may include at least one selected from the group consisting of aluminum (Al), copper (Cu), silver (Ag), an aluminum (Al) alloy, a copper (Cu) alloy, a silver (Ag) alloy and combinations thereof.

In an exemplary embodiment of the present invention, the patterning of the gate metal layer may further include removing the deformation preventing layer. In one exemplary embodiment, the patterning the gate metal layer and removing the deformation preventing layer may be performed substantially simultaneously by a same etching solution.

In an exemplary embodiment of the present invention, a thickness of the gate metal layer may be about 1 μm to about 10 μm. In one exemplary embodiment, a thickness of the deformation preventing layer may be no more than half of the thickness of the gate metal layer. In one exemplary embodiment, the thickness of the deformation preventing layer may be thinner than that of the gate metal layer by about 1.34 μm to about 1.36 μm.

In an exemplary embodiment of the present invention, an adhesive layer may be further formed between the base substrate and the gate metal layer. In one exemplary embodiment, the adhesive layer may include at least on selected from the group consisting of molybdenum (Mo), titanium (Ti), molybdenum titanium (MoTi), copper oxide (CuO), molybdenum niobium (MoNb), cobalt (Co), nickel (Ni), aluminum (Al), tantalum (Ta), and combinations thereof.

In an exemplary embodiment of the present invention, the base substrate may be heated.

In an exemplary embodiment of the present invention, the deformation preventing layer may include an organic insulation layer. In one exemplary embodiment, the organic insulation layer may be a film. In one exemplary embodiment, the deformation preventing layer may include an inorganic insulation layer.

According to another exemplary of the present invention, a method of manufacturing a display substrate includes; disposing a deformation preventing layer on an upper surface of a base substrate, wherein the deformation preventing layer applies a force to the base substrate to prevent the base substrate from bending, disposing a gate metal layer on the deformation preventing layer, patterning the gate metal layer to form a gate line, disposing a data line crossing the gate line on the base substrate, and disposing a pixel electrode on the base substrate.

According to another exemplary embodiment of the present invention, a method of manufacturing a display substrate includes disposing a gate metal layer on an upper surface of a base substrate, forming a gate line from the gate metal layer using a line photoresist pattern corresponding to a gate line and a dummy photoresist pattern, disposing a data line crossing the gate line on the base substrate, disposing a pixel electrode on the base substrate, and using the dummy photoresist pattern to etch the gate line to have a tapered angle.

In an exemplary embodiment of the present invention, a planarization layer is disposed on the base substrate, a planarization layer corresponding to the gate line is removed by performing a rear surface exposing process with respect to the base substrate, a gate insulation layer is disposed on the gate line and the planarization layer.

In an exemplary embodiment of the present invention, a thickness of the gate line may be substantially thicker than that of the gate insulation layer. In one exemplary embodiment, the thickness of the gate line is about 0.5 μm to about 3.0 μm.

In an exemplary embodiment of the present invention, the gate metal layer corresponding to the dummy photoresist pattern may be further removed when the gate line is formed.

In an exemplary embodiment of the present invention, a line width of the dummy photoresist pattern may be substantially smaller than that of the gate line. In one exemplary embodiment, the line width of the dummy photoresist pattern may be about 3 μm to about 4 μm.

In an exemplary embodiment of the present invention, an interval distance between individual lines of the dummy photoresist pattern may be about 3 μm to about 300 μm. In one exemplary embodiment, a tapered angle of the gate line may be about 80 degrees to about 90 degrees.

In an exemplary embodiment of the present invention, at least one branch shape may be repeatedly formed to form the dummy photoresist pattern. In one exemplary embodiment, the branch shape may include at least one of an I-shape, a rectangular shape, a circular shape, and a V-shape.

According to another exemplary embodiment of the present invention, a method of manufacturing a display substrate includes; disposing a gate metal layer on an upper surface of a base substrate, spraying an etching solution from a nozzle on an area areas where etching solution from adjacent nozzles is sprayed, patterning the gate metal layer using the etching solution, disposing a data line crossing a gate line patterned from the gate metal layer, and disposing a pixel electrode on the base substrate.

In an exemplary embodiment of the present invention, a line photoresist pattern corresponding to the gate line and a dummy photoresist pattern of a branch shape may be used during patterning the gate metal layer. In one exemplary embodiment, a distance between adjacent nozzles may be about 0 nm to about 60 nm. In one exemplary embodiment, a radius of an area where the etching solution is sprayed may be about 35 mm to about 60 mm

According to exemplary embodiments of a display substrate and a method of manufacturing the display substrate, a symmetric force is applied to the display substrate during a manufacturing process of the display substrate, so that the base substrate may not be bent. Furthermore, defects such as a nonplanarization at the following process of a gate patterning and a generation of a stepped difference may be prevented.

### BRIEF DESCRIPTION OF THE DRAWINGS

The above and other aspects, features and advantages of the present invention will become more apparent by describing in further detail exemplary embodiments thereof with reference to the accompanying drawings, in which:

FIG. 1 is a top plan view illustrating a first exemplary embodiment of a display substrate according to the present invention;

FIG. 2 is a cross-sectional schematic view taken along line I-I′ of FIG. 1;

FIGS. 3A to 3F are cross-sectional schematic views illustrating an exemplary embodiment of a manufacturing process of the exemplary embodiment of a display substrate of FIG. 2;

FIG. 4 is a graph illustrating a thickness of a deformation preventing layer which is deposited to prevent a bending defect of an exemplary embodiment of a display substrate during a manufacturing process thereof as shown in FIGS. 3A to 3F;

FIG. 5 is a cross-sectional schematic view illustrating a second exemplary embodiment of a display substrate according to the present invention;

FIGS. 6A to 6F are cross-sectional schematic views illustrating an exemplary embodiment of a manufacturing process of an exemplary embodiment of a display substrate of FIG. 5;

FIG. 7 is a cross-sectional schematic view illustrating a third exemplary embodiment of a display substrate according to the present invention;

FIGS. 8A to 8F are cross-sectional schematic views illustrating an exemplary embodiment of a manufacturing process of the exemplary embodiment of a display substrate of FIG. 6;

FIG. 9 is a cross-sectional schematic view illustrating a fourth exemplary embodiment of a display substrate according to the present invention;

FIGS. 10A to 10F are cross-sectional schematic views illustrating an exemplary embodiment of a manufacturing process of the exemplary embodiment of a display substrate of FIG. 9;

FIG. 11 is a cross-sectional schematic view illustrating a fifth exemplary embodiment of a display substrate according to the present invention;

FIG. 12 is a partial top plan view illustrating a dummy photoresist pattern and a line photoresist pattern used in an exemplary embodiment of a manufacturing process of an exemplary embodiment of a display substrate of FIG. 11;

FIGS. 13A to 13D are schematic top plan views illustrating various shapes of the exemplary embodiment of a dummy photoresist pattern of FIG. 12;

FIGS. 14A to 14H are cross-sectional schematic views illustrating an exemplary embodiment of a manufacturing process of the exemplary embodiment of a display substrate of FIG. 11;

FIGS. 15A to 15C are cross-sectional schematic views illustrating a variation of cut dimension (“CD”) skew of the dummy photoresist pattern and the gate metal layer positioned below the dummy photoresist pattern in accordance with a time during an exemplary embodiment of a manufacturing process of the fifth exemplary embodiment of a display substrate;

FIG. 16A is a cross-sectional schematic view illustrating an exemplary embodiment of an etching apparatus for manufacturing a sixth exemplary embodiment of a display substrate;

FIG. 16B is a top plan view illustrating a position of nozzles of the exemplary embodiment of an etching apparatus and areas of an etching solution which is sprayed from the nozzles; and

FIGS. 17A to 17E are cross-sectional schematic views illustrating an exemplary embodiment of a manufacturing process of the sixth exemplary embodiment of a display substrate.

### DETAILED DESCRIPTION OF THE INVENTION

The invention now will be described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. Like reference numerals refer to like elements throughout.

It will be understood that when an element or layer is referred to as being “on,” another element, it can be directly on, connected or coupled to the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

### Exemplary Embodiment 1

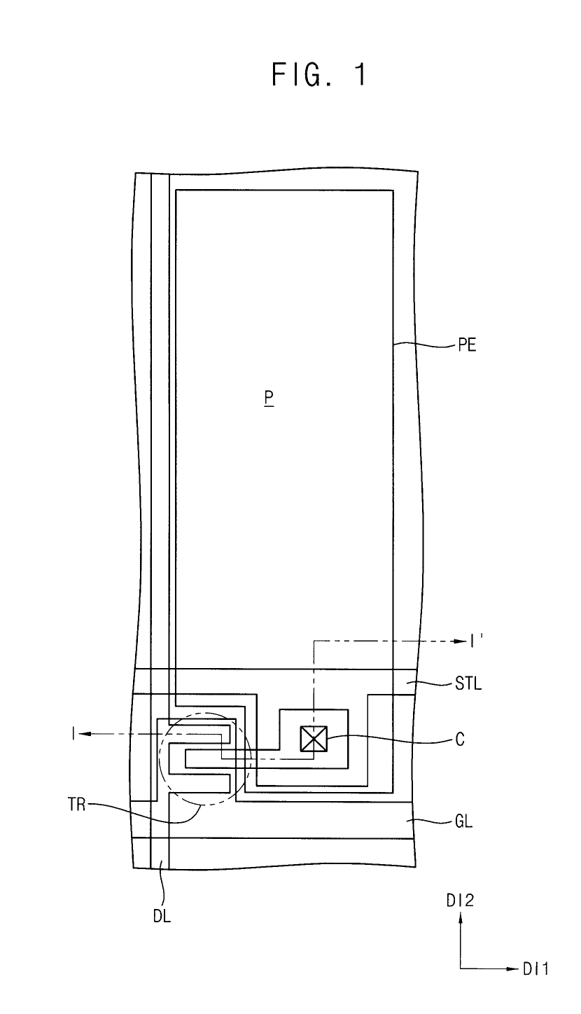

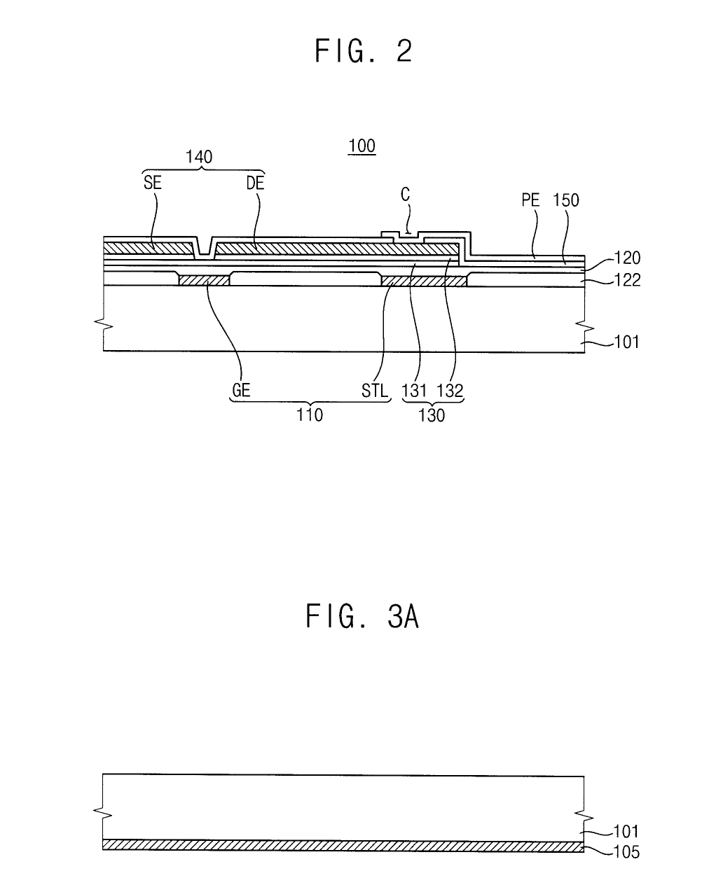

FIG. 1 is a top plan view illustrating a first exemplary embodiment of a display substrate 100 according to the present invention. FIG. 2 is a cross-sectional schematic view taken along line I-I′ of FIG. 1.

Referring to FIGS. 1 and 2, the display substrate 100 includes a base substrate 101.

A gate line GL, a gate electrode GE, a storage line STL, a planarization layer 122, a gate insulation layer 120, a channel layer 130, a data metal layer 140 including a data line DL, a source electrode SE and a drain electrode DE, a protective insulation layer 150 and a pixel electrode PE are formed on the base substrate 101.

In the present exemplary embodiment, the gate line GL is extended in a first direction DI1. In one exemplary embodiment, the gate electrode GE may connect to a portion of the gate line GL. Alternative exemplary embodiments include configurations wherein the gate electrode GE may be protruded from the gate line GL.

In the present exemplary embodiment, the storage line STL may be formed substantially in parallel with the gate line GL. Alternative exemplary embodiments include configurations wherein the storage line STL may be formed substantially in parallel with the data line DL. The storage line STL overlaps with the pixel electrode PE formed at a pixel area P, so that the storage line STL and the pixel electrode PE that are overlapped with each other may form a storage capacitor. Alternative exemplary embodiments include configurations wherein the storage line STL may be omitted.

The planarization layer 122 is formed on the base substrate 101 except on an area corresponding to the conductive pattern, for example, the gate line GL, the gate electrode GE and the storage line STL. In one exemplary embodiment, the planarization layer 122 may be a negative type organic layer. The planarization layer 122 may reduce a step difference generated due to an increase of thicknesses of the gate line GL, the gate electrode GE and the storage line STL. In the present exemplary embodiment, the gate lien GL, the gate electrode GE and the storage line STL may have greater thicknesses than in comparative display substrates in order to reduce a resistance thereof.

Then, the gate insulation layer 120 covers the planarization layer 122, the gate line GL, the gate electrode GE and the storage line STL.

The channel layer 130 is disposed on the gate insulation layer 120. In the present exemplary embodiment, the channel layer 130 includes a semiconductor layer 131 doped with dopants and an ohmic contact layer 132 disposed between the source and drain electrodes SE and DE to reduce a contact resistance thereof.

In the present exemplary embodiment, the data line DL is extended in a second direction DI2 crossing the first direction DI1. In one exemplary embodiment, the source electrode SE is connected to a portion of the data line DL and overlaps the gate electrode GE. Alternative exemplary embodiments include configurations wherein the source electrode SE is extended from the data line DL toward an area on which the gate electrode GE is formed to overlap with the gate electrode GE.

The drain electrode DE is spaced apart from the source electrode SE to overlap with the gate electrode GE. The gate electrode GE, the channel layer 130, the source electrode and the drain electrode DE may form a switching element TR connected to the gate line GL and the data line DL.

The protective insulation layer 150 is formed to cover the base substrate on which the switching element TR is formed. In one exemplary embodiment, the protective insulation layer 150 may have a double layer structure including a passivation layer and an organic layer having a large thickness. Alternative exemplary embodiments include configurations wherein the protective insulation layer 150 may have a single layer structure.

The pixel electrode PE is formed on the protective insulation layer 150 corresponding to the pixel area P. The pixel electrode PE contacts the drain electrode DE through the contact hole C. In one exemplary embodiment, the pixel electrode PE may include an optically transparent and electrically conductive material. An alignment layer (not shown) may be formed on the pixel electrode PE to align liquid crystal molecules of a liquid crystal layer (not shown).

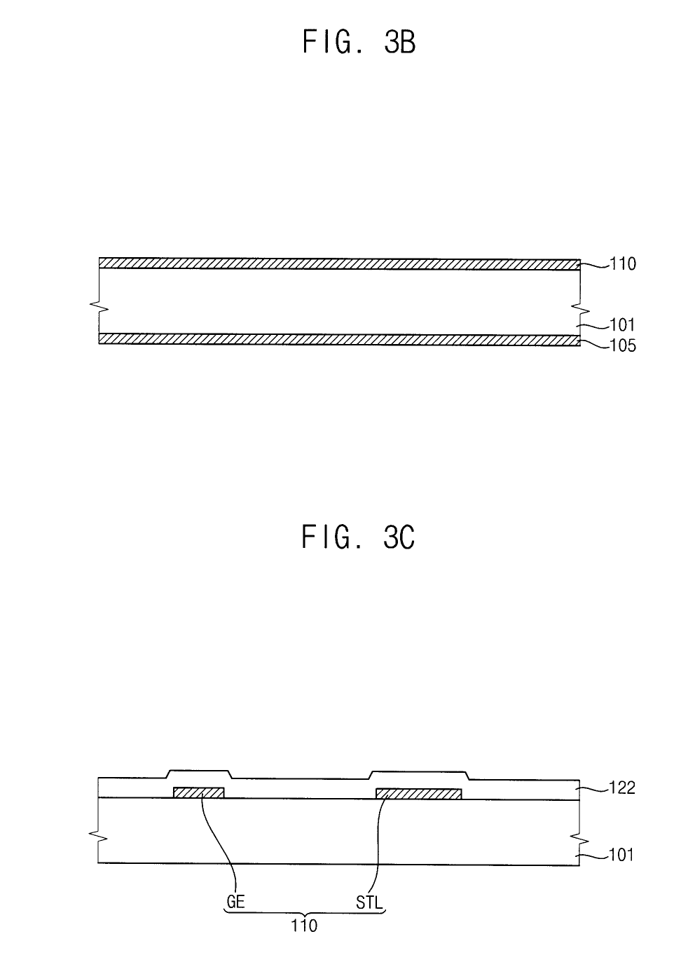

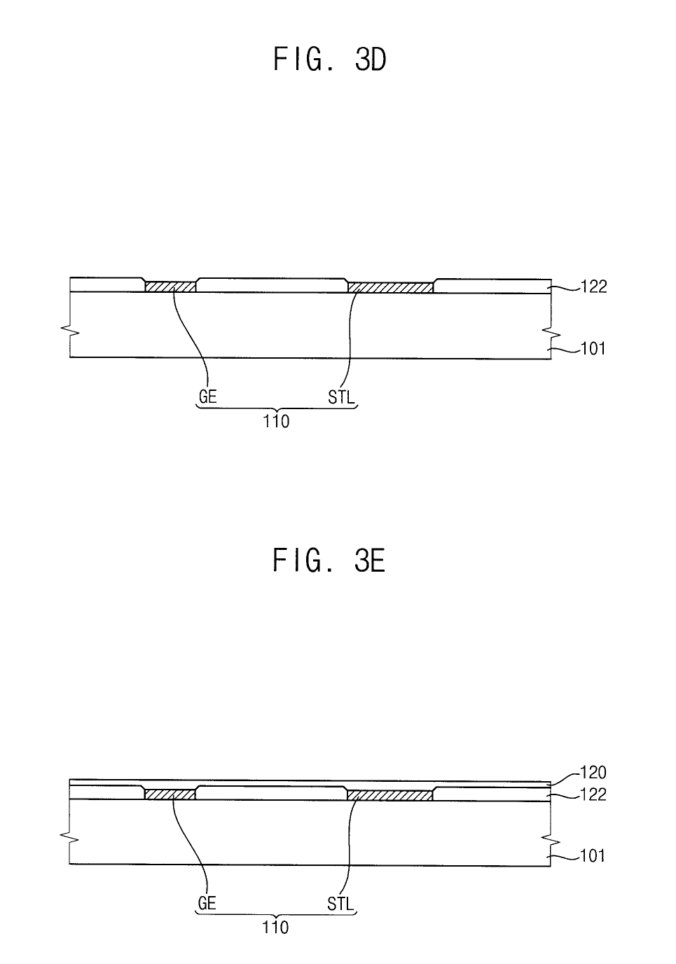

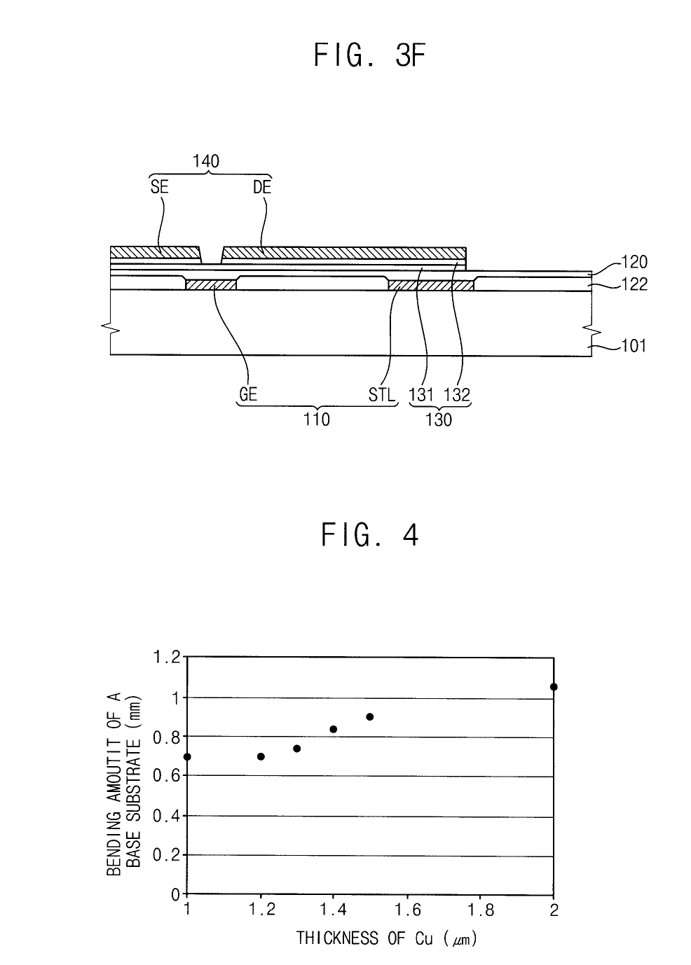

FIGS. 3A to 3F are cross-sectional schematic views illustrating an exemplary embodiment of a manufacturing process of the exemplary embodiment of a display substrate of FIG. 2.

Referring to FIGS. 2 and 3A, a deformation preventing layer 105 is deposited on a lower surface of the base substrate 101. In one exemplary embodiment, the deformation preventing layer is deposited through a chemical vapor deposition (“CVD”) process, a sputtering process or other similar processes. Alternative exemplary embodiments include configurations wherein the deformation preventing layer 105 may be deposited on the lower surface of the base substrate 101 through a coating process, an inkjet process, a gravia coating process, or other similar processes. Exemplary embodiments include configurations wherein the deformation preventing layer 105 may be an organic layer or an inorganic layer.

In one exemplary embodiment, the deformation preventing layer 105 may include a metal material such as aluminum (Al), copper (Cu), silver (Ag), an aluminum alloy, a copper alloy, a silver alloy, or other materials having similar characteristics. In the present exemplary embodiment, the deformation preventing layer 105 may have a tensile stress applied thereto. The tensile stress applied to the deformation preventing layer 105 means that the deformation preventing layer applies a force to the base substrate 101 in a substantially opposite direction and of substantially equal magnitude to a bending force applied to the base substrate 101 by the gate metal layer described below. The deformation preventing layer functions so that two end portions of the base substrate 101 having the deformation preventing layer 105 formed thereon are bent toward a counter direction of the bending force applied to the base substrate 101.

A magnitude of the tensile stress of the deformation preventing layer 105 is decreased when a temperature of the base substrate 101 is decreased.

Referring to FIGS. 2 and 3B, a gate metal layer 110 is deposited on an upper surface of the base substrate 101, e.g., in one exemplary embodiment it is formed through a chemical vapor deposition (“CVD”) process, a sputtering process or other similar process. Alternative exemplary embodiments include configurations wherein the gate metal layer 110 may be deposited on the upper surface of the base substrate 101 through a coating process, an inkjet process, a gravia coating process, or other similar processes. As described above, exemplary embodiments of the gate metal layer 110 may include a metal material such as aluminum (Al), copper (Cu), silver (Ag), an aluminum (Al) alloy, a copper (Cu) alloy, a silver (Ag) alloy, or other materials having similar characteristics. In the present exemplary embodiment, the gate metal layer 110 has a tensile stress applied thereto. Here, the tensile stress of the gate metal layer 110 means that the gate metal layer 110 applies a force to the base substrate 101 in a substantially opposite direction and of a substantially opposite direction to a bending force applied to the base substrate 101. The gate metal layer 110 functions so that two end portions of the base substrate 101 having the gate metal layer 110 formed thereon are bent toward a counter direction of the bending force applied to the base substrate 101. A magnitude of the tensile stress of the gate metal layer 110 is decreased when a temperature of the base substrate 101 is decreased. In one exemplary embodiment, the force applied to the base substrate 101 by the deformation preventing layer 105 is substantially equal to and opposite a bending force applied to the base substrate 101 by the gate metal layer 110.

In one exemplary embodiment, an adhesive layer (not shown) may be formed between the gate metal layer 110 and the base substrate 101. The adhesive layer may include molybdenum (Mo), titanium (Ti), a molybdenum titanium alloy (MoTi), copper oxide (CuO), molybdenum niobium (MoNb), cabalt (Co), nickel (Ni), aluminum (Al), tantalum (Ta), and other materials having similar characteristics. In one exemplary embodiment, the adhesive layer (not shown) has a relatively high adhesive property for affixing it to the base substrate 101 made of a glass material, so that it may compensate for a low adhesive property of the gate metal layer 110 to the base substrate 101.

Then, the base substrate 101 on which the gate metal layer 110 and the deformation preventing layer 105 are deposited may be heat treated at a high temperature. A strength of a tensile stress applied to the heat treated base substrate 101 is smaller than that of a tensile stress applied to the base substrate 101 prior to heat treatment, so that a bend amount of the base substrate 101 may be decreased.

The deformation preventing layer 105 and the gate metal layer 110, which are deposited on two surfaces of the base substrate 101 by interposing the base substrate 101 therebetween, have a tensile stress applied thereto. Thus, as a bending force is applied to a central portion of the base substrate 101, the base substrate 101 does not bend towards any side thereof. That is, the gate metal layer 110 having a tensile stress applied thereto is formed on an upper surface of the base substrate 101 and the deformation preventing layer 105 having a tensile stress applied thereto is formed on a lower surface of the base substrate 101, so that it does not bend with an upper surface or a lower surface of the base substrate 101.

Referring to FIGS. 2 and 3C, a photoresist layer is formed on the gate metal layer 110, and then the photoresist layer is partially exposed. Here, a mask is disposed on the base substrate 101, which includes a light-blocking portion in correspondence with the gate line GL, the gate electrode GE and the storage line STL that form a first conductive pattern. Thus, at least a portion of the photoresist layer not removed during the first exposure remains, which corresponds to a non-exposed area by the light-blocking portion. That is, the exposed photoresist layer is developed to form a first photoresist pattern. The gate metal layer 110 is etched using the first photoresist pattern formed on the gate metal layer 110 as an etch stop layer, so that the gate line GL, the gate electrode GE and the storage line STL that together form a first conductive pattern are formed on the base substrate 101. In this exemplary embodiment, it is described that the first photoresist pattern is a positive type photoresist material. Alternative exemplary embodiments include configurations wherein the first photoresist pattern may be formed from a negative type photoresist material.

When the gate metal layer 110 is etched, the gate metal layer 110 and the deformation preventing layer 105 may be etched using an identical etching solution. In the present exemplary embodiment, the deformation preventing layer 105 is removed. In one exemplary embodiment, all of the deformation preventing layer 105 may be removed by the etching.

In one exemplary embodiment, the deformation preventing layer 105 may be a non-transparent metal layer. Moreover, the deformation preventing layer 105 may perform a role of preventing the base substrate 101 from being bent, when the gate metal layer 110 is deposited on the base substrate 101 and the gate metal layer 110 is patterned. Thus, when the gate metal layer 110 is etched, a whole of the deformation preventing layer 105 may be removed so that it prevents light from not being passed the display substrate 100 when a manufacturing process of the display substrate 100 is completed.

In the present exemplary embodiment, the gate metal layer 105 is etched through a time etching method. The time etching method is an etching method that data for an etching time of a metal layer is obtained in advance and then the deformation preventing layer 105 is etched in accordance with the obtained data. That is, a whole of the deformation preventing layer 105 is removed after a time corresponding to the obtained data. In one exemplary embodiment, the time etching method may be performed during a wet-etching process.

Then, a planarization layer 122 is formed on the base substrate 101 on which the first metal pattern is formed.

Referring to FIGS. 2 and 3D, a portion of the planarization layer 122 corresponding to the first metal pattern is removed. In one exemplary embodiment, the planarization layer 122 covering the gate line GL, the gate electrode GE and the storage line STL does not receive light through a rear surface of the base substrate 101. The planarization layer 122 which does not receive light is removed, thereby removing a portion of the planarization layer which corresponds to the gate line GL, the gate electrode GE and the storage line STL, which in the present exemplary embodiment are formed from a non-transparent metal layer.

Thus, a thickness of the planarization layer 122 is substantially the same as a thickness of the gate electrode GE and the storage line STL.

Referring to FIGS. 2 and 3E, a gate insulation layer 120 is formed on the planarization layer 122. Exemplary embodiments of the gate insulation layer 120 may include a silicon nitride (SiNx), a silicon oxide (SiOx), etc.

Referring to FIGS. 2 and 3F, a channel layer 130 including a semiconductor layer 131 and an ohmic contact layer 132 is formed on the base substrate 101 on which the gate insulation layer 120 is formed. In one exemplary embodiment, the semiconductor layer 131 is an amorphous silicon doped layer doped with N type dopants at a high concentration, and the ohmic contact layer 132 is an amorphous silicon (a-Si) layer.

A data metal layer 140 is formed on the channel layer 130, and the data metal layer 140 is patterned to form a second conductive pattern including a data line DL, a source electrode SE and a drain electrode DE. Exemplary embodiments of the data metal layer 140 may include a metal material such as chromium (Cr), chromium (Cr) alloy, molybdenum (Mo), molybdenum sodium (MoNa), molybdenum niobium (MoNb), a molybdenum (Mo) alloy, copper (Cu), a copper (Cu) alloy, a copper molybdenum (CuMo) alloy, aluminum (Al), an aluminum (Al) alloy, silver (Ag), a silver (Ag) alloy, and other materials having similar characteristics.

In this exemplary embodiment, the channel layer 130 and the data metal layer 140 are formed through one mask, so that the channel layer 130 is formed below the second conductive pattern. Alternative exemplary embodiments include configurations wherein the channel layer 130 and the data metal layer 140 may be formed through different mask processes to form the channel layer 130 on only the gate electrode GE.

Referring again FIG. 2, a protective insulation layer 150 is formed on the data metal layer 140 and the gate insulating layer 120. Exemplary embodiments include configurations wherein the protective insulation layer 150 may have a single layer structure as illustrated in FIG. 2 or a double layer structure including a passivation layer and an organic layer and having a thicker thickness than the single layer structure. Although the above exemplary embodiment discusses a single layer structure and a double layer structure, a multi-layer structure such as a triple layer structure, a fourfold layer structure or any other configuration known to one of ordinary skill in the art may also be utilized in place of or in conjunction with the single layer structure.

A contact hole C exposing the drain electrode DE is formed through the protective insulation layer 150 formed on the base substrate 101. In one exemplary embodiment, the contact hole C is formed using an etching process. A transparent conductive layer is formed on the protective layer 150 having the contact hole C formed therethough, and the transparent conductive layer is patterned to form a third conductive pattern including a pixel electrode PE. Exemplary embodiments of the transparent conductive layer may include an optically transparent and electrically conductive material such as indium tin oxide (“ITO”), indium zinc oxide (“IZO”) and other materials having similar characteristics.

FIG. 4 is a graph illustrating a thickness of a deformation preventing layer which is deposited to prevent bending of a display substrate during a manufacturing process of a display substrate of FIGS. 3A to 3F.

Table 1 shows thicknesses of a deformation preventing layer 105 which will be deposition to prevent bending of a display substrate during a manufacturing process of a display substrate of FIGS. 3A to 3F.

TABLE 1

| | Bending | | | Thickness of metal |
|---|---|---|---|---|
| | amount | Bending | | layer which will be |
| Thickness of | of a base | amount | Bendable | deposited on a lower |
| Deposition | substrate | of Cu | amount of Cu | surface of substrate |
| (μm) | (mm) | (mm) | (mm) | (μm) |
| 0.1 | 0.35 | 0.04 | −0.46 | |
| 0.2 | 0.39 | 0.07 | −0.43 | |
| 0.3 | 0.43 | 0.11 | −0.39 | |
| 0.4 | 0.46 | 0.15 | −0.35 | |
| 0.5 | 0.50 | 0.19 | −0.31 | |
| 0.6 | 0.54 | 0.22 | −0.28 | |
| 0.7 | 0.57 | 0.26 | −0.24 | |
| 0.8 | 0.61 | 0.30 | −0.20 | |
| 0.9 | 0.65 | 0.33 | −0.17 | |
| 1.0 | 0.69 | 0.37 | −0.13 | |
| 1.1 | 0.72 | 0.41 | −0.09 | |
| 1.2 | 0.76 | 0.44 | −0.06 | |
| 1.3 | 0.80 | 0.48 | −0.02 | |
| 1.4 | 0.83 | 0.52 | 0.02 | 0.05 |
| 1.5 | 0.87 | 0.56 | 0.06 | 0.15 |
| 1.6 | 0.9 | 0.59 | 0.06 | 0.25 |
| 1.7 | 0.94 | 0.63 | 0.13 | 0.35 |
| 1.8 | 0.98 | 0.67 | 0.17 | 0.45 |
| 1.9 | 1.02 | 0.70 | 0.20 | 0.55 |
| 2 | 1.06 | 0.74 | 0.24 | 0.65 |

Referring to FIG. 4 and Table 1, a total range of a bending amount of the base substrate 101 is about 0.31 mm throughout the various thicknesses of the deformation preventing layer. Moreover, a bending amount of the gate metal layer 110 in accordance with a deposition thickness of the gate metal layer 110 will be described as follows.

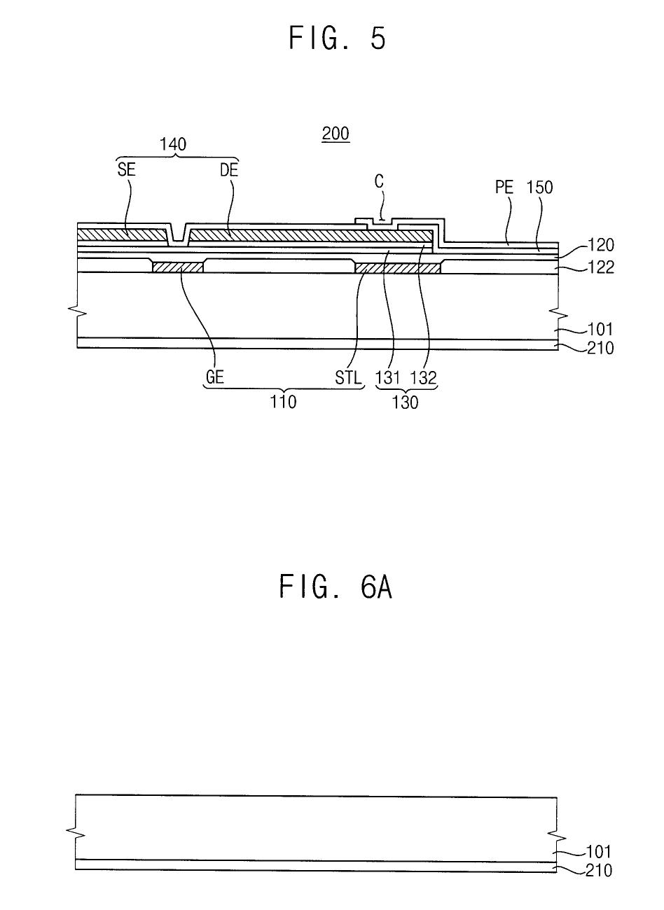

Here, the gate metal layer 110 is copper (Cu), as shown in graphs of FIGS. 4 and 5 and Table 1.

A bending measurement of the base substrate 101 was performed in the base substrate 101 having a length of about 400 nm to about 500 nm. Moreover, the bending measurement of the base substrate 101 was performed based on a difference between a height spaced apart from a center portion of the base substrate 101 by about 150 nm to about 200 nm and a height at a center portion of the base substrate 101.

When the gate metal layer 110 has a thickness of about 1 μm, the gate metal layer 110 may bend about 0.37 mm. That is, when a bending amount of an initial base substrate 101 is added to a bending amount of the gate metal layer 110, the base substrate 101 on which the gate metal layer 110 is deposited may be bent about 0.69 mm.

Here, a bending amount of the gate metal layer 110 is about 0.37 mm, which is no more than about 0.5 mm, so that a manufacturing process of the display substrate 100 may be easily performed. Thus, the deformation preventing layer 105 may not be required, so that a step of depositing the deformation preventing layer 105 may be omitted.

When the gate metal layer 110 has a thickness of about 1.2 μm, the gate metal layer 110 may bend about 0.44 mm. That is, when a bending amount of an initial base substrate 101 is added to a bending amount of the gate metal layer 110, the base substrate 101 on which the gate metal layer 110 is deposited may be bent about 0.76 mm.

Here, a bending amount of the gate metal layer 110 is about 0.44 mm, which is no more than about 0.5 mm, so that a manufacturing process of the display substrate 100 may be easily performed. Thus, the deformation preventing layer 105 may not be required, so that a step of depositing the deformation preventing layer 105 may be omitted.

When the gate metal layer 110 has a thickness of about 1.4 μm, the gate metal layer 110 may bend about 0.52 mm. That is, when a bending amount of an initial base substrate 101 is added to a bending amount of the gate metal layer 110, the base substrate 101 on which the gate metal layer 110 is deposited may be bent about 0.83 mm.

Here, a bending amount of the gate metal layer 110 is about 0.52 mm that is more than about 0.5 mm, so that a manufacturing process of the display substrate 100 may not be easily performed.

Thus, the deformation preventing layer 105 is deposited on a lower surface of the base substrate 101 in order to allow for an easier manufacturing process. Here, the thickness of the deformation preventing layer 105 deposited on the lower surface of the base substrate 101 may be calculated based on the graph shown in FIG. 4 and the table shown in FIG. 5.

In one exemplary embodiment, a thickness of the deformation preventing layer 105 may be no more than a half of a thickness of the gate metal layer 110.

As a bending amount of the gate metal layer 110 increases in proportioned to a depositing thickness of the gate metal layer 110, it is recognized that a bend amount of the gate metal layer 110 is about 0.5 mm when a depositing thickness of the gate metal layer 110 is between about 1.3 μm to about 1.4 μm.

Thus, the deformation preventing layer 105 may be deposited on a lower surface of the base substrate 101 at a thickness of about 0.05 μm, so that a difference between a depositing thickness of the gate metal layer 110 and a thickness of the deformation preventing layer 105 may be from about 1.34 μm to about 1.36 μm when the gate metal layer has a thickness of about 1.4 μm.

When the gate metal layer 110 has a thickness of about 1.6 μm, the gate metal layer 110 may be bent by about 0.59 mm. That is, when a bending amount of an initial base substrate 101 is added to a bending amount of the gate metal layer 110, the base substrate 101 on which the gate metal layer 110 is deposited may be bent by about 0.91 mm.

Here, a bending amount of the gate metal layer 110 is about 0.59 mm that is more than about 0.5 mm, so that a manufacturing process of the display substrate 100 may not be easily performed.

Thus, the deformation preventing layer 105 may be deposited on a lower surface of the base substrate 101 at a thickness of about 0.25 μm, so that a difference between a depositing thickness of the gate metal layer 110 and a thickness of the deformation preventing layer 105 may be from about 1.34 μm to about 1.36 μm in order to allow for an easier manufacturing process.

When the gate metal layer 110 has a thickness of about 1.8 μm, the gate metal layer 110 may be bent about 0.67 mm. That is, when a bending amount of an initial base substrate 101 is added to a bending amount of the gate metal layer 110, the base substrate 101 on which the gate metal layer 110 is deposited may be bent about 0.98 mm.

Here, a bending amount of the gate metal layer 110 is about 0.67 mm that is more than about 0.5 mm, so a manufacturing process of the display substrate 100 may not be easily performed.

Thus, the deformation preventing layer 105 may be deposited on a lower surface of the base substrate 101 at a thickness of about 0.45 μm, so that a difference between a depositing thickness of the gate metal layer 110 and a thickness of the deformation preventing layer 105 may be from about 1.34 μm to about 1.36 μm in order to allow for an easier manufacturing process.

When the gate metal layer 110 has a thickness of about 2 μm, the gate metal layer 110 may be bent by about 0.74 mm. That is, when a bending amount of an initial base substrate 101 is added to a bending amount of the gate metal layer 110, the base substrate 101 on which the gate metal layer 110 is deposited may be bent about 1.02 mm.

Here, a bending amount of the gate metal layer 110 is about 0.74 mm that is more than about 0.5 mm, so a manufacturing process of the display substrate 100 may not be easily performed.

Thus, the deformation preventing layer 105 may be deposited on a lower surface of the base substrate 101 at a thickness of about 0.65 μm, so that a difference between a depositing thickness of the gate metal layer 110 and a thickness of the deformation preventing layer 105 may be from about 1.34 μm to about 1.36 μm in order to allow for an easier manufacturing process.

When the thickness of the gate metal layer 110 is no more than about 1.4 μm, the deformation preventing layer 105 is deposited on a lower surface of the base substrate 101 as shown in FIG. 4 and Table 1.

According to the first exemplary embodiment, when the thickness of the gate metal layer 110 is in a range between about 1 μm to about 10 μm, the deformation preventing layer 105 maybe deposited on a lower surface of the base substrate 101.

As described above, the thickness of the deformation preventing layer 105 which will be deposited on the lower surface of the base substrate 101 will be described by a detailed equation.

Referring again to FIG. 4 and Table 1, a relationship between a thickness of the gate metal layer 110 and a bending amount of the base substrate 101 on which the gate metal layer 110 is deposited will be described as in the following Equation 1. Here, the reference symbol ‘Y’ denotes a bending amount of the base substrate 101 on which the gate metal layer 110 is deposited, and the reference symbol ‘X’ denotes a thickness of the gate metal layer 110.

Y=0.3707X+0.3144 <Equation 1>

A bending amount of the base substrate 101 is about 0.31 mm initially, so that a bend amount of the gate metal layer 110 deposited on the base substrate 101 may be described by the following Equation 2. Here, the reference symbol ‘A’ denotes a bend amount of the gate metal layer 110.

A=Y−0.31=0.3707X+0.3144−0.31=0.3707X+0.044 <Equation 2>

In order to easily realize a manufacturing process of the display substrate 100, the bend amount ‘A’ of the gate metal layer 110 maybe no more than about 0.5 mm. That is, in order to easily manufacture the display substrate 100, a bend amount of the gate metal layer 110 may be calculated by the following Equation 3. Here, the reference symbol ‘B’ denotes a bend amount of the gate metal layer 110 toward a counter direction thereof.

B=A−0.5=0.3707X+0.0044−0.5=0.3707X−0.4956 <Equation 3>

In order to obtain about 0.5 mm of ‘A’ for easily performing a manufacturing process, a thickness of the deformation preventing layer 105 which will be deposited on a lower surface of the base substrate 101 may be described by the following Equation 4. Here, the reference symbol ‘C’ denotes a thickness of the deformation preventing layer 105 which will be deposited on the lower surface of the base substrate 101.

$$C = \frac{B}{0.3707} = \frac{( 0.3707 X - 0.4956 )}{0.3707} = X - 1.35 \qquad < Equation 4 >$$

As described in Equation 4, a thickness of the deformation preventing layer 105 may be easily recognized to easily realize a manufacture process. For example, the thickness of the deformation layer 105 may be smaller than that of the gate metal layer 110 by about 1.34 μm to about 1.36 μm.

Accordingly, the deformation preventing layer 105 corresponding to the gate metal layer 110 is deposited when the gate metal layer 110 is deposited in a thicker thickness, so that a bending of the base substrate 101 due to the gate metal layer 110 of a thicker thickness may be prevented.

Moreover the gate metal layer 110 of a thicker thickness is manufactured, so that a resistance of a line is decreased. A dual gate structure used to create a large scale display substrate may be realized as a single gate structure based on the low resistance of the gate metal layer 110, so that an aperture ratio may be increased.

### Exemplary Embodiment 2

FIG. 5 is a cross-sectional schematic view illustrating a second exemplary embodiment of a display substrate according to the present invention.

A top plan view of the display substrate illustrated in FIG. 5 is substantially similar to that of the first exemplary embodiment of a display substrate illustrated in FIG. 1, and thus, a detailed description thereof will be omitted.

Moreover, the second exemplary embodiment of a display substrate illustrated in FIG. 5 is substantially similar to the display substrate illustrated in FIG. 2 except that a deformation preventing layer 210 is further included. Thus, identical reference numerals are used in FIG. 5 to refer to components that are the same or like those shown in FIG. 2, and thus, a detailed description thereof will be omitted.

Referring to FIGS. 2 and 5, the display substrate 200 includes a base substrate 101.

A gate line GL, a gate electrode GE, a storage line STL, a planarization layer 122, a gate insulation layer 120, a channel layer 130, a data line DL, a source electrode SE, a drain electrode DE, a protective insulation layer 150 and a pixel electrode PE are formed on an upper surface of the base substrate 101. A deformation preventing layer 210 is formed on a lower surface of the base substrate 101.

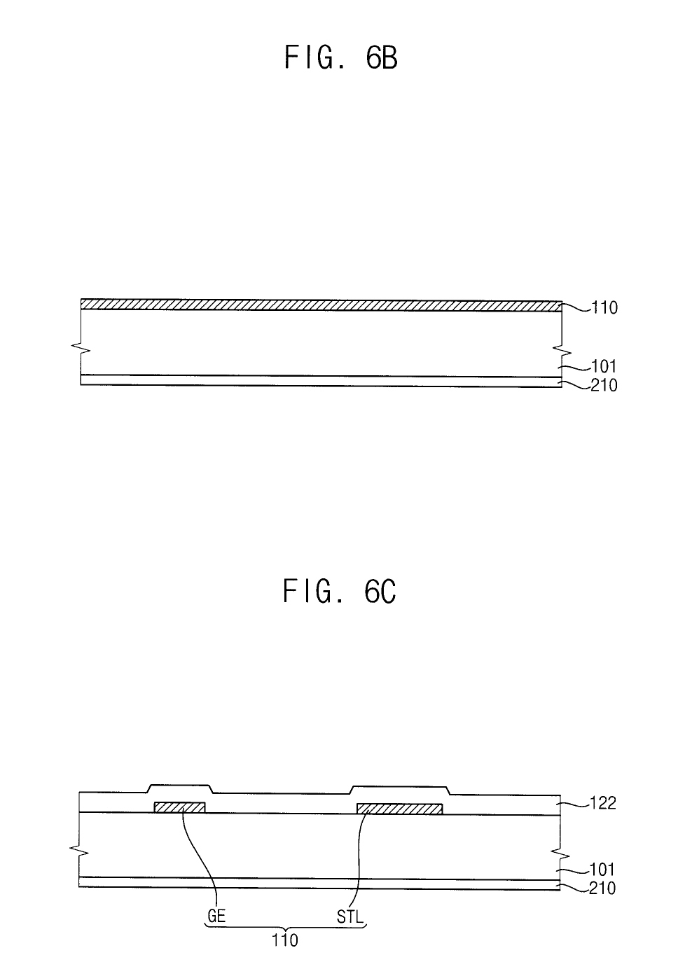

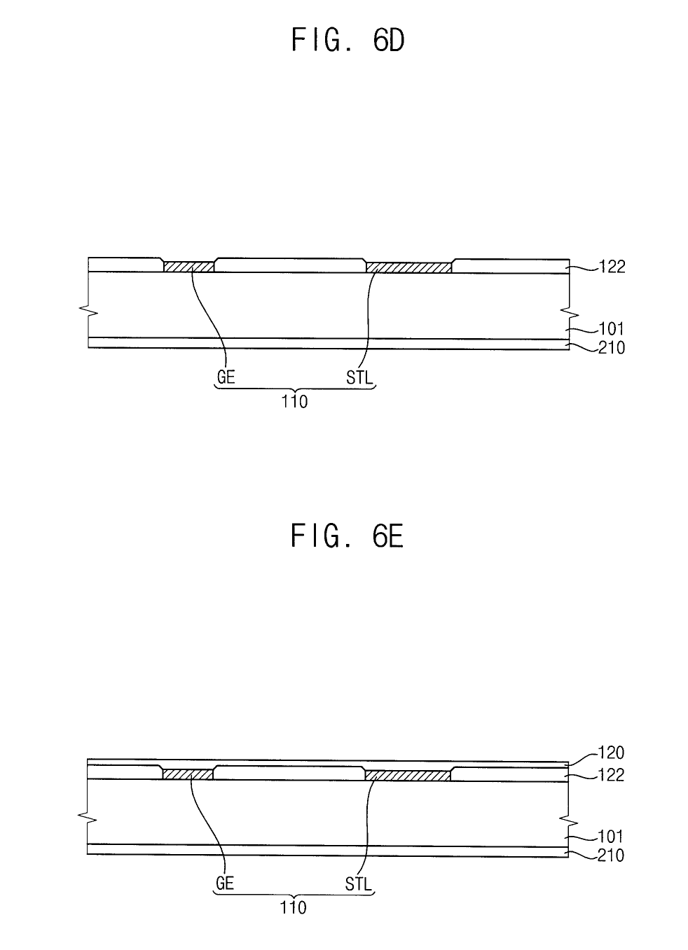

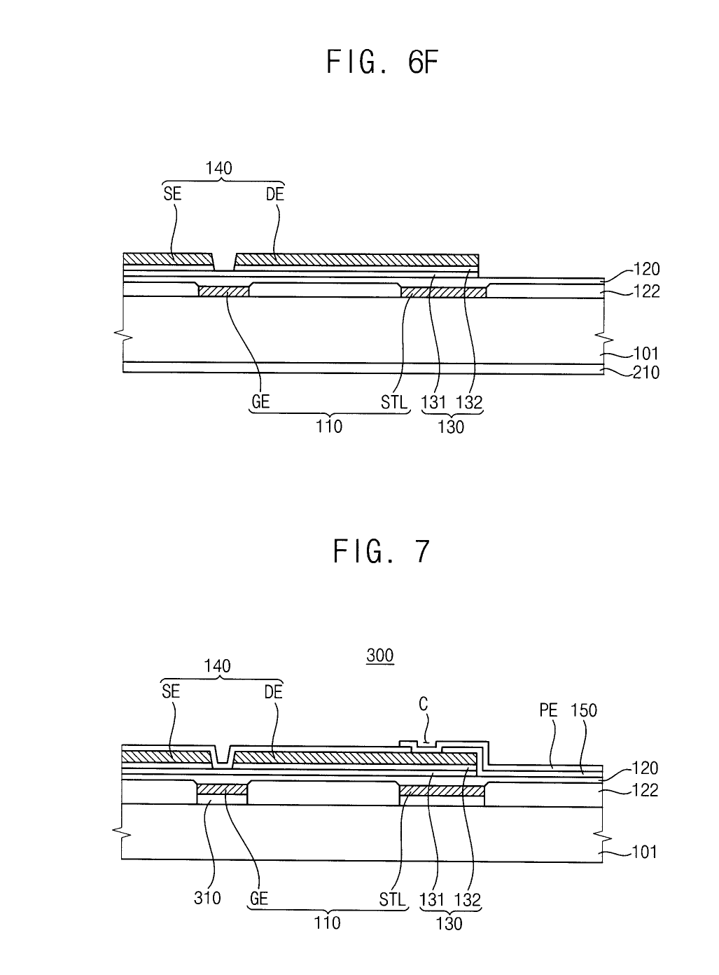

FIGS. 6A to 6F are cross-sectional views illustrating a manufacturing process of a display substrate of FIG. 5.

Referring to FIGS. 5 and 6A, a deformation preventing layer 210 is deposited on a lower surface of the base substrate 101, e.g., through a CVD process. a sputtering process or other similar process. Alternative exemplary embodiments include configurations wherein the deformation preventing layer 210 may be deposited on the lower surface of the base substrate 101 through various coating techniques such as a coating process, an inkjet process, a gravia coating process, and other similar processes. In one exemplary embodiment, the deformation preventing layer 210 may include an organic insulation layer or an inorganic insulation layer. In one exemplary embodiment, the deformation preventing layer 210 may include one of a silicon nitride (SiNx) and a silicon oxide (SiOx).

Referring to FIGS. 5 and 6B, a gate metal layer 110 is deposited on the base substrate 101, e.g., through a CVD process, a sputtering process, or other similar process. Alternative exemplary embodiments include configurations wherein, the gate metal layer 110 may be deposited on the base substrate 101 through various coating techniques such as a coating process, an inkjet process, a gravia coating process, and other similar processes. Exemplary embodiments of the gate metal layer 110 may include a metal material such as aluminum (Al), copper (Cu), silver (Ag), an aluminum (Al) alloy, a copper (Cu) alloy, a silver (Ag) alloy, and other materials with similar characteristics.

The deformation preventing layer 210 deposited on a lower surface of the base substrate 101 has a tensile stress applied thereto, and the gate metal layer 110 also has a tensile stress applied thereto.

Here, the tensile stress of the deformation preventing layer 210 means that a bend force in which two end portions of the base substrate 101 having the deformation preventing layer 210 formed thereon are bent toward an opposite direction of the base substrate 101 as a bending force in which two end portions of the base substrate 101 having the gate metal layer 110 formed thereon are bent.

Thus, as a force which bends with an opposition direction is applied with respect to a central portion of the base substrate 101, the base substrate 101 does not bend towards any side thereof.

Here, a silicon nitride (SiNx) and a silicon oxide (SiOx) layer, which form the deformation preventing layer 210, may have a tensile stress or a compression stress applied thereto due to an exterior condition such as a depositing pressure, etc. In the second exemplary embodiment, the deformation preventing layer 210 may have a tensile stress applied thereto.

A method of manufacturing the second exemplary embodiment of a display substrate illustrated in FIGS. 6C to 6F is substantially the same as the method of manufacturing the first exemplary embodiment of a display substrate illustrated in FIGS. 3C to 3F except that a deformation preventing layer 210 is further formed. Thus, identical reference numerals are used in FIGS. 6C to 6F to refer to components that are the same or like those shown in FIGS. 3C to 3F, and thus, a detailed description thereof will be omitted.

According to the second exemplary embodiment of the present invention, the deformation preventing layer 210 corresponding to the gate metal layer 110 is deposited when the gate metal layer 110 is deposited at a large thickness, so that a bending of the base substrate 101 due to the gate metal layer 110 having a thick thickness may be prevented.

Moreover, the gate metal layer 110 having a large thickness is manufactured, so that a resistance of a signal line is decreased. A dual gate structure used to construct a large scale display substrate may be realized as a single gate structure based on the low resistance of the gate metal layer 110, so that an aperture ratio may be increased.

### Exemplary Embodiment 3

FIG. 7 is a cross-sectional schematic view illustrating a display substrate according to a third exemplary embodiment of the present invention.

A plan view of the third exemplary embodiment of a display substrate illustrated in FIG. 7 is substantially the same as that of the first exemplary embodiment f a display substrate illustrated in FIG. 1, and thus, a detailed description thereof will be omitted.

Moreover the third exemplary embodiment of a display substrate illustrated in FIG. 7 is substantially the same as the display substrate illustrated in FIG. 2 except that a deformation preventing layer 310 is further included. Thus, identical reference numerals are used in FIG. 7 to refer to components that are the same or like those shown in FIG. 2, and thus, a detailed description thereof will be omitted.

Referring to FIGS. 2 and 7, the display substrate 300 includes a base substrate 101.

A deformation preventing layer 310, a gate line GL, a gate electrode GE, a storage line STL, a planarization layer 122, a gate insulation layer 120, a channel layer 130, a data line DL, a source electrode SE, a drain electrode DE, a protective insulation layer 150 and a pixel electrode PE are formed on an upper surface of the base substrate 101.

The deformation preventing layer 310 is formed on the upper surface of the base substrate 101.

In the present exemplary embodiment, the gate line GL is extended in a first direction DI1 on the deformation preventing layer 310.

The gate electrode GE may be connected to a portion of the gate line GL. Alternative exemplary embodiments include configurations wherein the gate electrode GE may be protruded from the gate line GL. In one exemplary embodiment, the storage line STL may be formed substantially in parallel with the gate line GL. Alternative exemplary embodiments include configurations wherein the storage line STL may be formed substantially in parallel with the data line DL. The storage line STL overlaps with the pixel electrode PE formed at a pixel area P, so that the storage line STL and the pixel electrode PE that are overlapped with each other may form a storage capacitor.

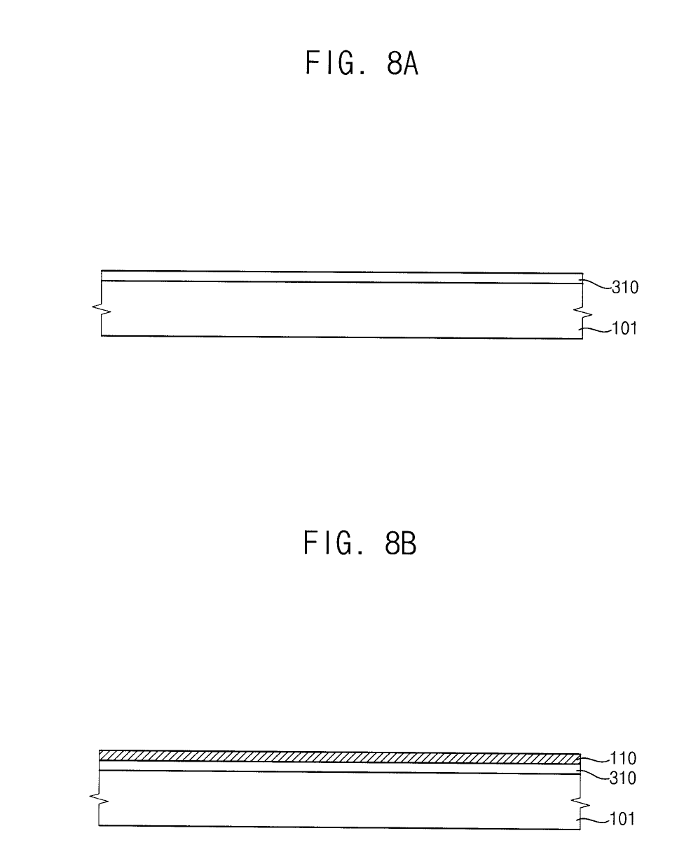

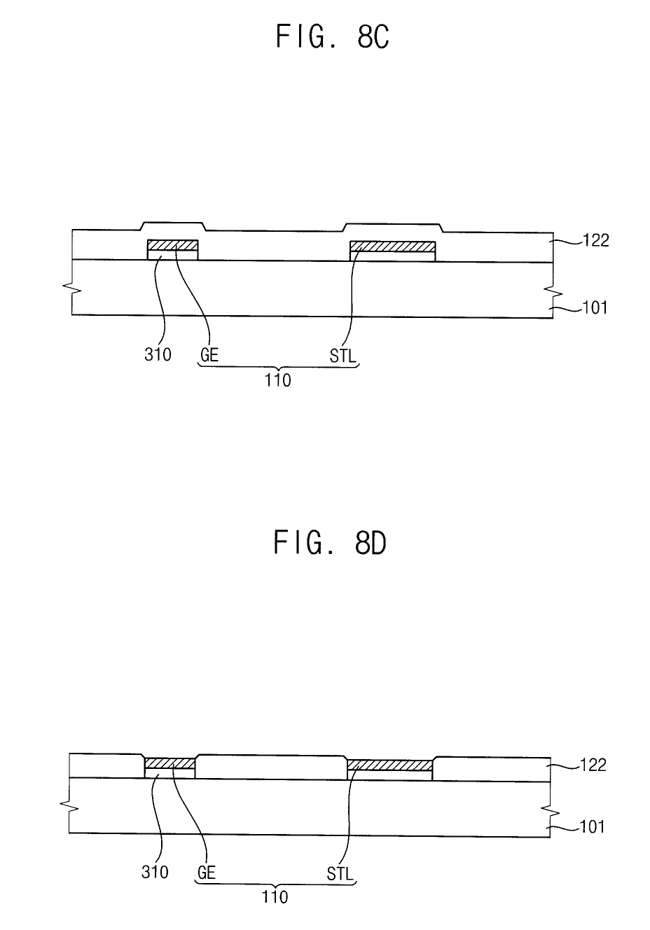

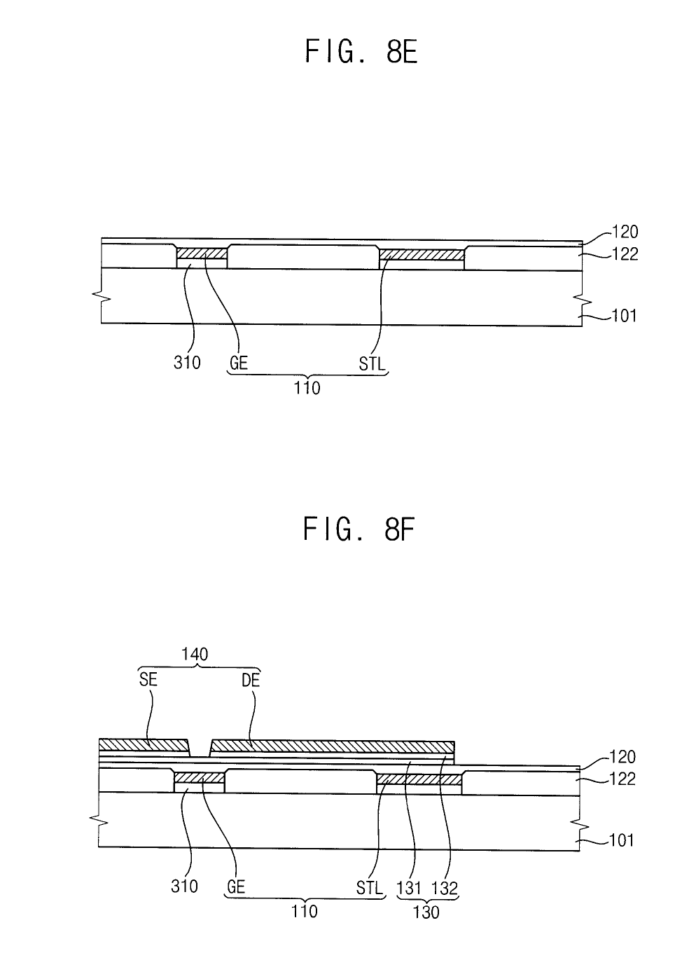

FIGS. 8A to 8F are cross-sectional schematic views illustrating an exemplary embodiment of a manufacturing process of a display substrate of FIG. 6.

Referring to FIGS. 7 and 8A, a deformation preventing layer 310 is deposited on an upper surface of the base substrate 101, e.g., through a CVD process, a sputtering process or other similar process. Alternative exemplary embodiments include configurations wherein the deformation preventing layer 310 may be deposited on the upper surface of the base substrate 101 through various coating techniques such as a coating process, an inkjet process, a gravia coating process, or other similar process. In one exemplary embodiment, the deformation preventing layer 310 may include an organic insulation layer or an inorganic insulation layer. In one exemplary embodiment, the deformation preventing layer 310 may include one of silicon nitride (SiNx), titanium nitride (TiNx), molybdenum nitride (MoNx), silicon oxide (SiO2), copper oxide (CuOx), copper nitride (CuNx), ITO, IZO and other materials having similar characteristics.

Referring to FIGS. 7 and 8B, a gate metal layer 110 is deposited on the deformation preventing layer 310, e.g., through a CVD process, a sputtering process or other similar process. Alternative exemplary embodiments include configurations wherein the gate metal layer 110 may be deposited on the base substrate 101 through various coating techniques such as a coating process, an inkjet process, a gravia coating process, or other similar process. Exemplary embodiments of the gate metal layer 110 may include a metal material such as aluminum (Al), copper (Cu), silver (Ag), an aluminum (Al) alloy, a copper (Cu) alloy, a silver (Ag) alloy, or other materials having similar characteristics.

Referring to FIGS. 7 and 8C, a photoresist layer is formed on the gate metal layer 110, and then the photoresist layer is partially exposed. Here, a mask is disposed on the base substrate 101, which includes a light-blocking portion in correspondence with the gate line GL, the gate electrode GER and the storage line STL that form a first conductive pattern. Thus, a photoresist layer is remained, which corresponds to a non-exposed area due to the light-blocking portion. That is, the exposed photoresist layer is developed to form a first photoresist pattern. The gate metal layer 110 and the deformation preventing layer 310 are simultaneously etched using the first photoresist pattern formed on the gate metal layer 110 as an etch stop layer, so that the gate line GL, the gate electrode GE and the storage line STL that form a first conductive pattern are formed on the base substrate 101. In the above-described exemplary embodiment, the first photoresist pattern is a positive type photoresist material. Alternative exemplary embodiments include configurations wherein the first photoresist pattern may be formed from a negative type photoresist material.

An exemplary embodiment of a method of manufacturing the display substrate illustrated in FIGS. 8D to 8F is substantially the same as the method of manufacturing the display substrate illustrated in FIGS. 3D to 3F except that a deformation preventing layer 310 is further formed. Thus, identical reference numerals are used in FIGS. 8D to 8F to refer to components that are the same or like those shown in FIGS. 3D to 3F, and thus, a detailed description thereof will be omitted.

In the present exemplary embodiment, the deformation preventing layer 310 deposited on the base substrate 101 has a compression stress, and the gate metal layer 110 has a tensile stress applied thereto. The compression stress of the deformation preventing layer 310 means that a bend force in which two end portions of the base substrate 101 having the deformation preventing layer 310 formed thereon are bent in a direction toward a middle of the base substrate 101. Moreover, the tensile stress applied to the gate metal layer 110 means that a bend force in which two end portions of the base substrate 101 having the gate metal layer 110 formed thereon are bent in a direction counter to the direction of the direction of the compression stress applied to the deformation prevention layer 310.

Thus, the compression stress and the tensile stress are offset with each other, so that a bending of the base substrate 101 toward one direction maybe prevented.

According to the third exemplary embodiment of the present invention, the deformation preventing layer 310 corresponding to the gate metal layer 110 is deposited when the gate metal layer 110 is deposited in a large thickness, so that a bending of the base substrate 101 due to the gate metal layer 110 of a large thickness may be prevented.

Moreover, the gate metal layer 110 of a large thickness is manufactured, so that a resistance of a signal line is decreased. A dual gate structure used in a large scale display substrate may be realized as a single gate structure based on the low resistance of the gate metal layer 110, so that an aperture ratio may be increased.

### Example Embodiment 4

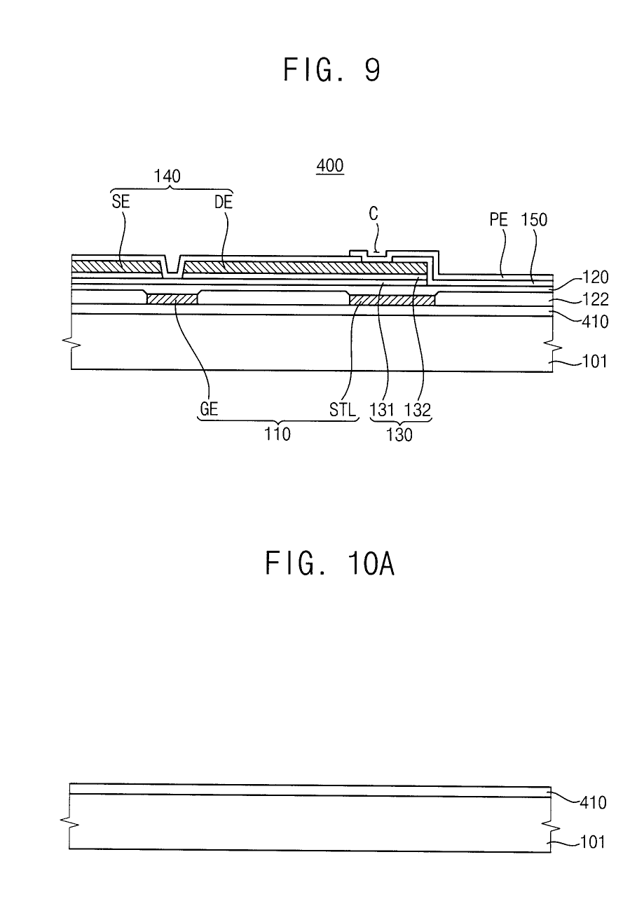

FIG. 9 is a cross-sectional schematic view illustrating a fourth exemplary embodiment of a display substrate according to the present invention.

A top plan view of the display substrate illustrated in FIG. 9 is substantially similar to that of the first exemplary embodiment of a display substrate illustrated in FIG. 1, and thus, a detailed description thereof will be omitted.

Moreover, the present exemplary embodiment of a display substrate illustrated in FIG. 9 is substantially the same as the exemplary embodiment of a display substrate illustrated in FIG. 2 except that a deformation preventing layer 410 is further included. Thus, identical reference numerals are used in FIG. 9 to refer to components that are the same or like those shown in FIG. 2, and thus, a detailed description thereof will be omitted.

Referring to FIGS. 2 and 9, the display substrate 400 includes a base substrate 101.

A deformation preventing layer 410, a gate line GL, a gate electrode GE, a storage line STL, a planarization layer 122, a gate insulation layer 120, a channel layer 130, a data line DL, a source electrode SE, a drain electrode DE, a protective insulation layer 150 and a pixel electrode PE are formed on an upper surface of the base substrate 101.

The deformation preventing layer 410 is formed on the upper surface of the base substrate 101. In the present exemplary embodiment, the gate line GL is extended in a first direction DI1 on the deformation preventing layer 410. In one exemplary embodiment, the gate electrode GE may be connected to a portion of the gate line GL. Alternative exemplary embodiments include configurations wherein the gate electrode GE may be protruded from the gate line GL. In one exemplary embodiment, the storage line STL may be formed substantially in parallel with the gate line GL. Alternative exemplary embodiments include configurations wherein the storage line STL may be formed substantially in parallel with the data line DL. The storage line STL overlaps with the pixel electrode PE formed at a pixel area P, so that the storage line STL and the pixel electrode PE that are overlapped with each other may form a storage capacitor.

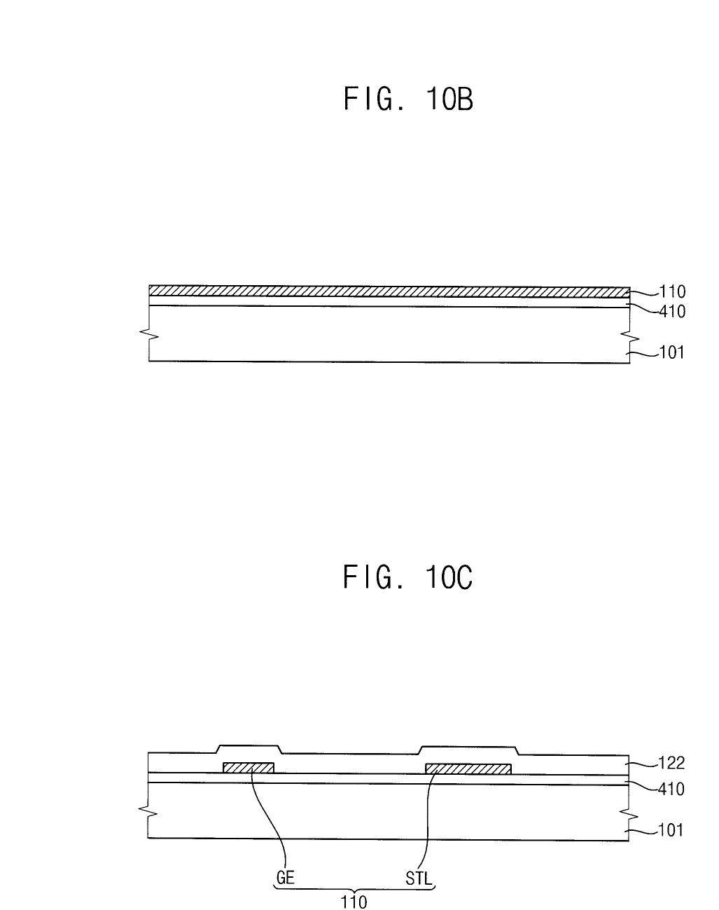

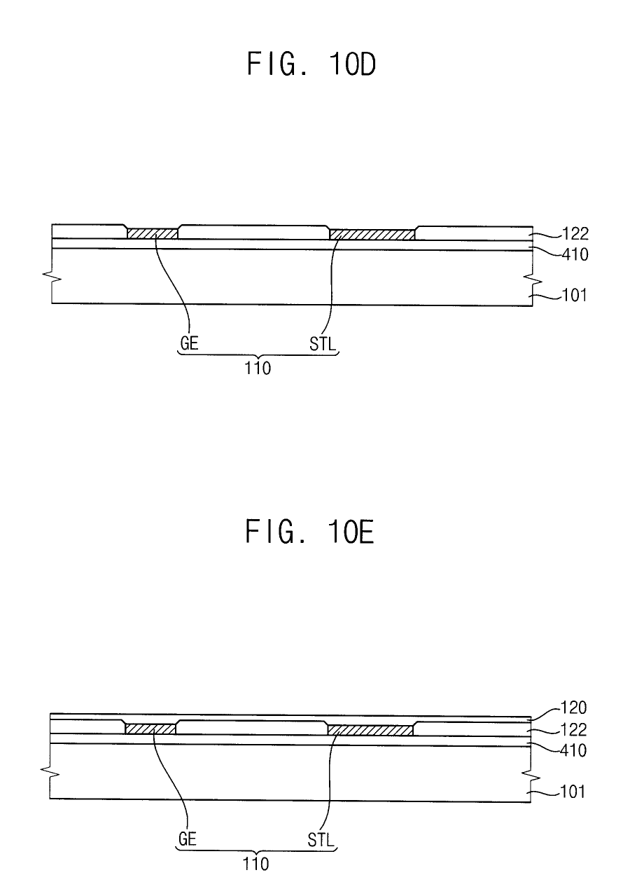

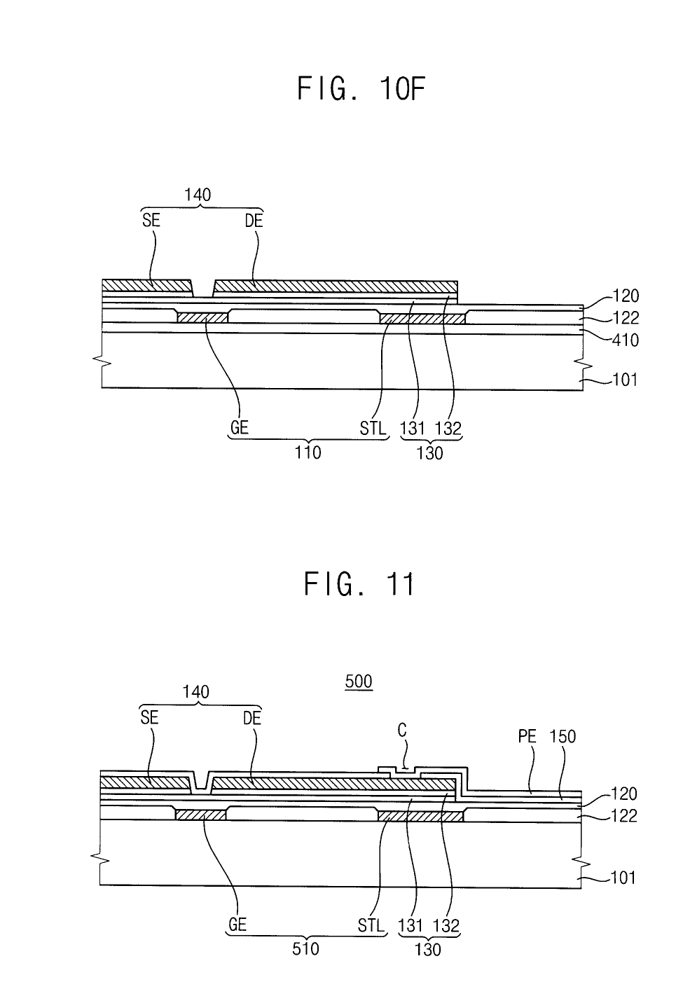

FIGS. 10A to 10F are cross-sectional schematic views illustrating an exemplary embodiment of a manufacturing process of an exemplary embodiment of a display substrate as illustrated in FIG. 9.

Referring to FIGS. 9 and 10A, a deformation preventing layer 410 is deposited on an upper surface of the base substrate 101, e.g., through a CVD process, a sputtering process, or other similar process. Alternative exemplary embodiments include configurations wherein the deformation preventing layer 410 may be deposited on the upper surface of the base substrate 101 through various coating techniques such as a coating process, an inkjet process, a gravia coating process, and other similar processes. In one exemplary embodiment, the deformation preventing layer 410 may include an organic insulation layer or an inorganic insulation layer. In one exemplary embodiment, the deformation preventing layer 410 may include one of a silicon nitride (SiNx) and a silicon oxide (SiOx).

Referring to FIGS. 9 and 10B, a gate metal layer 110 is deposited on the deformation preventing layer 410. In one exemplary embodiment, the gate metal layer 110 is deposited through a CVD process, a sputtering process or other similar process. Alternative exemplary embodiments include configurations wherein the gate metal layer 110 may be deposited on the upper surface of the base substrate 101 through various coating techniques such as a coating process, an inkjet process, a gravia coating process, and other various processes. In one exemplary embodiment, the gate metal layer 110 may include a metal material such as aluminum (Al), copper (Cu), silver (Ag), an aluminum (Al) alloy, a copper (Cu) alloy, a silver (Ag) alloy, and other materials having similar characteristics.

In the present exemplary embodiment, the deformation preventing layer 410 deposited on the base substrate 101 has a compression stress applied thereto, and the gate metal layer 110 has a tensile stress applied thereto. Here, the compression stress of the deformation preventing layer 410 means that a bending force in which two end portions of the base substrate 101 having the deformation preventing layer 410 formed thereon are bent in a direction toward a middle of the base substrate 101. Moreover, the tensile stress of the gate metal layer 110 means that a bending force in which two end portions of the base substrate 101 having the gate metal layer 110 formed thereon are bent in a direction counter to a direction of the compression stress applied to the deformation prevention layer 410.

Thus, the compression stress applied to an upper surface of the base substrate 101 and the tensile stress are offset with each other, so that a bending of the base substrate 101 toward one direction may be prevented.

In the present exemplary embodiment, a silicon nitride (SiNx) and a silicon oxide (SiOx) layer, which form the deformation preventing layer 410, may be determined as a condition whether or not it has a tensile stress or a compression stress due to an exterior condition such as a depositing pressure, etc. In the fourth exemplary embodiment, the deformation preventing layer 410 may have a compression stress applied thereto.

An exemplary embodiment of a method of manufacturing the exemplary embodiment of display substrate illustrated in FIGS. 10C to 10F is substantially the same as the exemplary embodiment of a method of manufacturing the display substrate illustrated in FIGS. 3C to 3F except that a deformation preventing layer 410 is further included. Thus, identical reference numerals are used in FIGS. 10C to 10F to refer to components that are the same or like those shown in FIGS. 3C to 3F, and thus, a detailed description thereof will be omitted.

According to the fourth exemplary embodiment of the present invention, the deformation preventing layer 410 corresponding to the gate metal layer 110 is deposited when the gate metal layer 110 is deposited in a large thickness, so that a bending of the base substrate 101 due to the gate metal layer 110 of a large thickness may be prevented.

Moreover, the gate metal layer 110 of a large thickness is manufactured, so that a resistance of a signal line is decreased. A dual gate structure used to create a large scale display substrate may be realized as a single gate structure based on the low resistance of the gate metal layer 10, so that an aperture ratio may be increased.

### Exemplary Embodiment 5

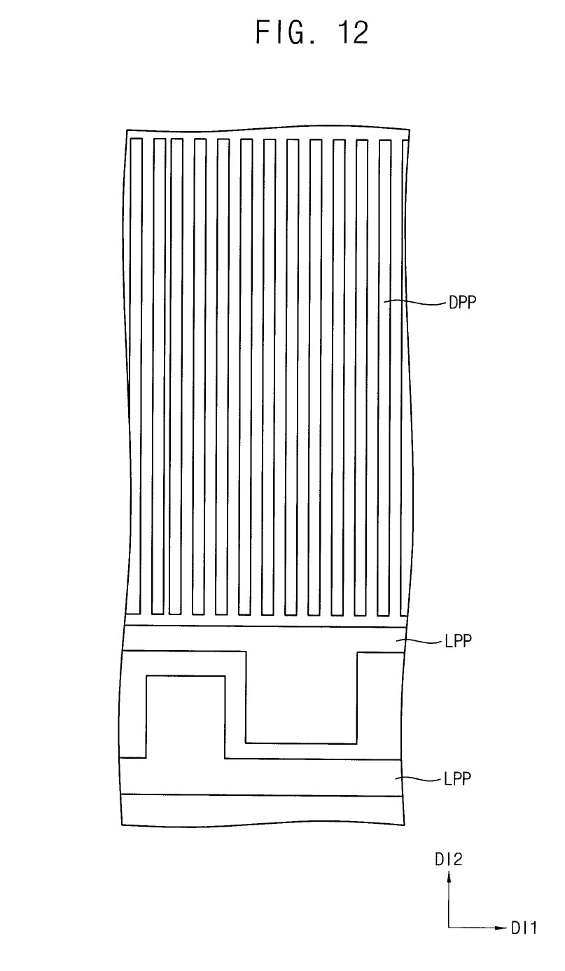

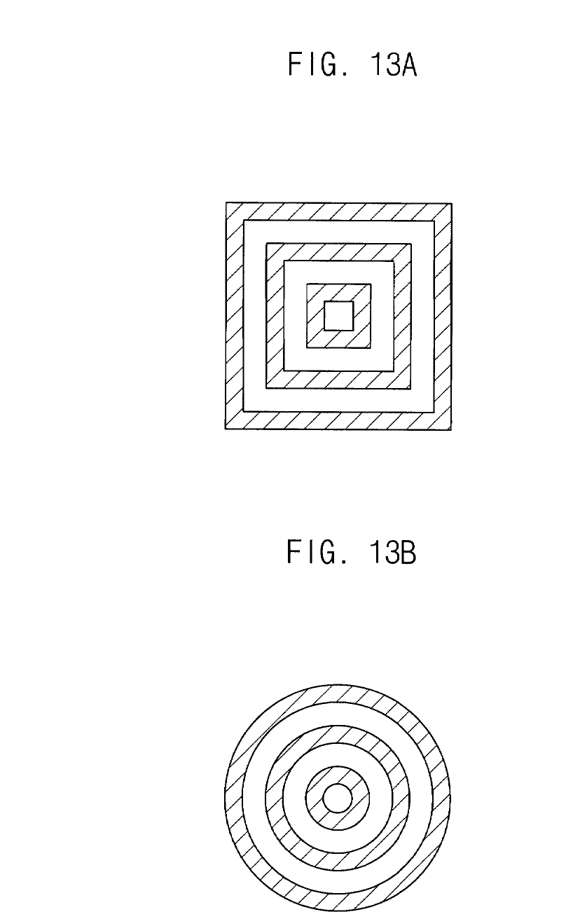

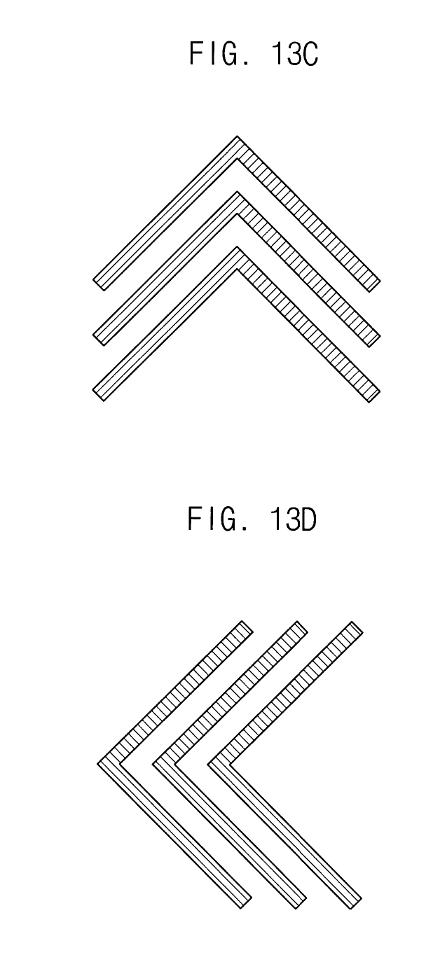

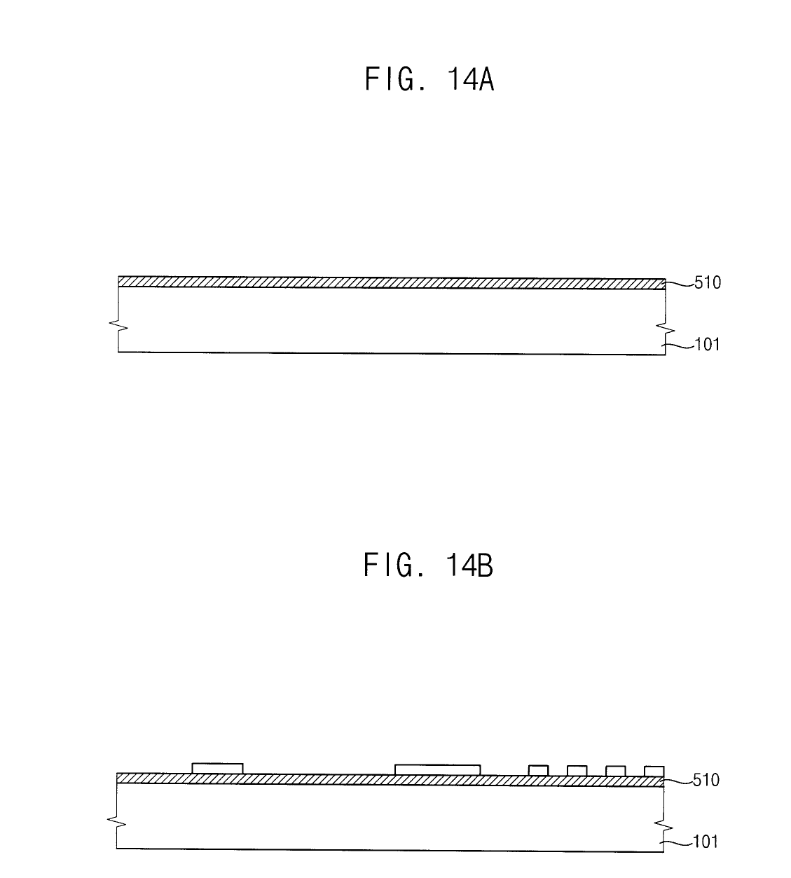

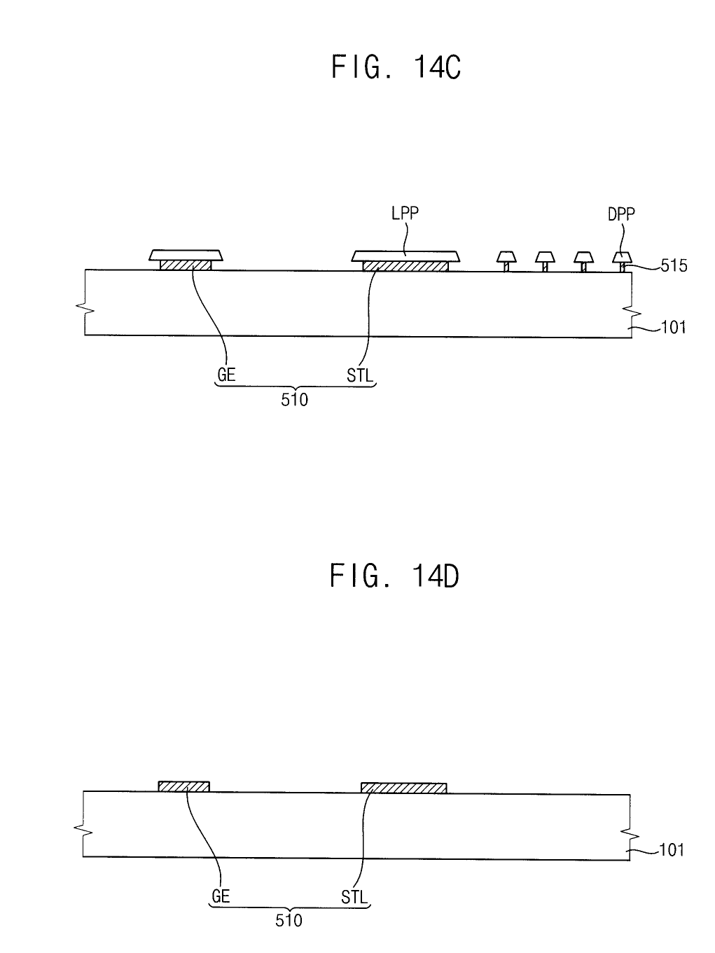

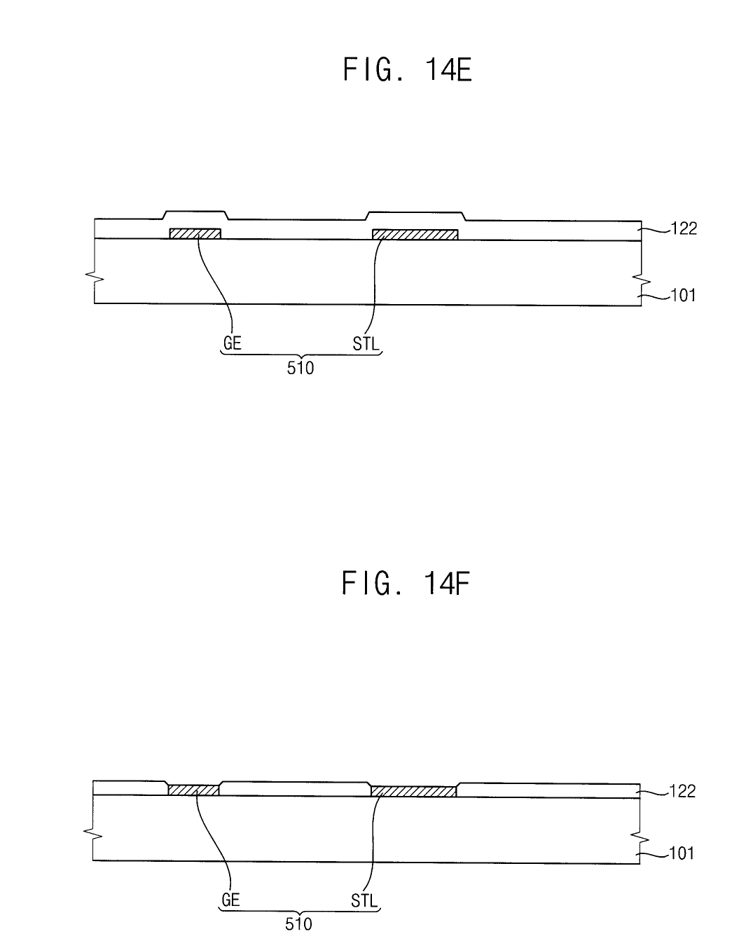

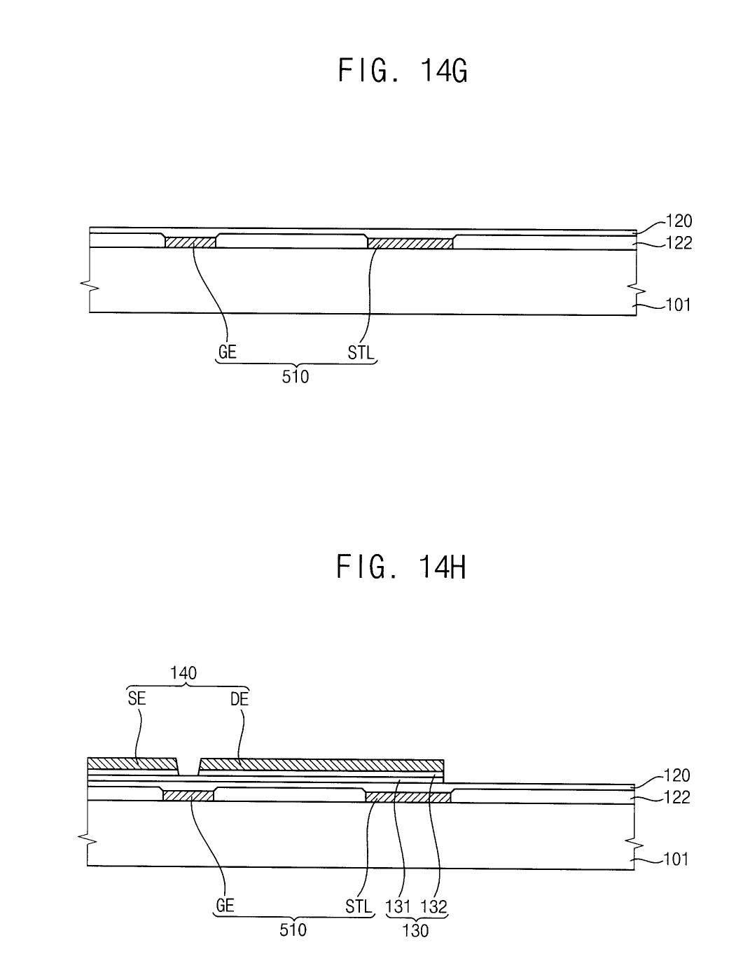

FIG. 11 is a cross-sectional schematic view illustrating a fifth exemplary embodiment of a display substrate according to the present invention. FIG. 12 is a partial top plan view illustrating a dummy photoresist pattern and a line photoresist pattern used in an exemplary embodiment of a manufacturing process of a display substrate of FIG. 11. FIGS. 13A to 13D are schematic top plan views illustrating various shapes of the exemplary embodiment of a dummy photoresist pattern of FIG. 12. FIGS. 14A to 14H are cross-sectional schematic views illustrating an exemplary embodiment of a manufacturing process of an exemplary embodiment of a display substrate of FIG. 11.

The display substrate illustrated in FIG. 11 is substantially similar to the first exemplary embodiment of a display substrate illustrated in FIG. 1. Moreover, the display substrate illustrated in FIG. 11 is substantially similar to the display substrate illustrated in FIG. 2 except that the dummy photoresist pattern DPP is further used during a manufacturing process. Thus, identical reference numerals are used in FIG. 11 to refer to components that are the same or like those shown in FIG. 2, and thus, a detailed description thereof will be omitted.

Referring to FIG. 11, the display substrate 500 includes a base substrate 101.

A gate line GL, a gate electrode GE, a storage line STL, a planarization layer 122, a gate insulation layer 120, a channel layer 130, a data line DL, a source electrode SE, a drain electrode DE, a protective insulation layer 150 and a pixel electrode PE are formed on an upper surface of the base substrate 101.

Referring to FIGS. 11 to 14A, a gate metal layer 510 is deposited on an upper surface of the base substrate 101 through a CVD process, a sputtering process or other similar process. Alternative exemplary embodiments include configurations wherein the gate metal layer 510 may be deposited on the upper surface of the base substrate 101 through various coating techniques such as a coating process, an inkjet process, a gravia coating process, and other similar methods. Exemplary embodiments of the gate metal layer 510 may include a metal material such as aluminum (Al), copper (Cu), silver (Ag), an aluminum (Al) alloy, a copper (Cu) alloy, a silver (Ag) alloy, and other materials having similar characteristics. An adhesive layer (not shown) may be formed between the gate metal layer 510 and the base substrate 101. The adhesive layer may include molybdenum (Mo), titanium (Ti), molybdenum titanium (MoTi), copper oxide (CuO), molybdenum niobium (MoNb), cabalt (Co), nickel (Ni), aluminum (Al) and tantalum (Ta), and other materials having similar characteristics. The adhesive layer (not shown) has relatively high adhesive property to the base substrate 101 including a glass material, so that it may compensate that a low adhesive property of the gate metal layer 510 to the base substrate 101.

Then, a photoresist layer is formed on the gate metal layer 510, and the photoresist layer is partially exposed. Here, a mask is disposed on the base substrate 101, which includes a line light-blocking portion corresponding to the gate line GL, the gate electrode GE and the storage line STL that form a first conductive pattern and a dummy light-blocking portion corresponding to the remaining portion excluding the first conductive pattern.

Referring to the exemplary embodiments illustrated in FIGS. 11 to 14B, the dummy photoresist pattern DPP and the line photoresist pattern LPP may include a positive type photoresist material. In such an exemplary embodiment, a photoresist layer not exposed due to the line light-blocking portion and the dummy light-blocking portion may remain.

That is, the exposed photoresist layer is developed to form the dummy photoresist pattern DPP and the line photoresist pattern LPP. Here, the line photoresist pattern LPP may be used to form the gate line GL, the gate electrode GE and the storage line STL. Moreover, the dummy photoresist pattern DPP may perform a role of enhancing etching characteristics, so that a taper angle of the gate line GL, the gate electrode GE and the storage line STL is about 80 degrees to abut 90 degrees. In one exemplary embodiment, a line width of the dummy photoresist pattern DPP may be about 3 μm to about 4 μm.

The exemplary embodiment of the dummy photoresist pattern DPP as illustrated in FIG. 12 has a shape in which a plurality of branches connected to each other by a horizontal limb. Referring again to FIGS. 13A to 13D, exemplary embodiments of the dummy photoresist pattern DPP may have various shapes in which rectangular limbs and branches of different sizes are included, circular belts of different sizes are included, V-shape branches and limbs of different sizes are included, etc.

Referring to FIGS. 11 to 14C, the gate metal layer 510 is etched using the line photoresist pattern LPP formed on the gate metal layer 510 as an etch stop layer, so that the gate line GL, the gate electrode GE and the storage line STL that form a first conductive pattern are formed on the base substrate 101.

That is, the gate metal layer 510 except the gate metal layer 510 disposed below the line photoresist pattern LPP is removed. A small area that is smaller than the line photoresist pattern LPP may be formed in the gate metal layer 510 disposed below the line photoresist pattern LPP, and the small area is referred to as an undercut.

Here, almost of the dummy metal layer 515 disposed below the dummy photoresist pattern DPP is removed by the undercut during an etching process because a line width of the dummy photoresist pattern DPP is small.

Referring to FIGS. 11 to 14D, the dummy photoresist pattern DPP and the line photoresist pattern LPP are removed. Here, remaining portions of the dummy metal layer 515 below the dummy photoresist pattern DPP may be also removed. Thus, the gate line GL, the gate electrode GE and the storage line STL that are formed on the base substrate 101 remain. Here, a thickness of the gate line GL, the gate electrode GE and the storage line STL may be about 0.5 μm to about 3.0 μm.

Referring to FIGS. 11 to 14E, a planarization layer 122 is formed on the base substrate on which the first metal pattern is formed. In one exemplary embodiment, the planarization layer may include an organic material. In the exemplary embodiment wherein a display substrate employs a thicker gate line, the planarization layer may be formed between the gate line and the gate insulation layer in order to reduce step induced defects.

Referring to FIGS. 11 and 14E, an area of the planarization layer 122 corresponding to the first metal pattern is removed.

In one exemplary embodiment, the planarization layer 122 not covering the gate line GL, the gate electrode GE and the storage line STL receives light through a rear surface of the base substrate 101. The planarization layer 122 exposed to the light remains, while the portion of the planarization layer which corresponds to the gate line GL, the gate electrode GE and the storage line STL, that are a non-transparent metal layer, are removed.

Thus, a thickness of the planarization layer 122 is substantially the same as a thickness of the gate electrode GE and the storage line STL.

According to the fifth exemplary embodiment, a tapered angle of the gate line GL, the gate electrode GE and the storage line STL may be about 80 degrees to about 90 degrees. Thus, when the planarization layer 122 corresponding to the gate line GL, the gate electrode GE and the storage line STL is removed, a gap may be not generated between the planarization layer 122, the gate line GL, the gate electrode GE and the storage line STL. Therefore, defects due to a step difference may be prevented, during a subsequent process of a patterning process performed to form a gate line.

Referring to FIGS. 11 to 14G, a gate insulation layer 120 is formed. Exemplary embodiments of the gate insulation layer 120 may include a silicon nitride (SiNx), a silicon oxide (SiO2), and other materials having similar characteristics.

Referring to FIGS. 11 to 14H, a channel layer 130 including a semiconductor layer 131 and an ohmic contact layer 132 is formed on the base substrate 101 on which the gate insulation layer 120 is formed. In one exemplary embodiment, the semiconductor layer 131 is an amorphous silicon doped layer doped with N type dopants at a high concentration, and the ohmic contact layer 132 is an amorphous silicon (a-Si) layer.

A data metal layer 140 is formed on the channel layer 130, and a second conductive pattern which includes a data line DL, a source electrode SE and a drain electrode DE is formed using the data metal layer 140. Exemplary embodiments of the data metal layer 140 may include chromium (Cr), chromium (Cr) alloy, molybdenum (Mo), molybdenum sodium (MoNa), molybdenum niobium (MoNb), a molybdenum (Mo) alloy, copper (Cu), a copper (Cu) alloy, a copper molybdenum (CuMo) alloy, aluminum (Al), an aluminum (Al) alloy, silver (Ag), a silver (Ag) alloy, and other materials having similar characteristics.

In the present exemplary embodiment, the channel layer 130 and the data metal layer 140 are formed through one mask, so that the channel layer 130 is formed below the second conductive pattern. Alternative exemplary embodiments include configurations wherein the channel layer 130 and the data metal layer 140 may be formed through different mask processes to form the channel layer 130 on only the gate electrode GE.

Referring again to FIG. 11, a protective insulation layer 150 is formed on the data metal layer 140. Exemplary embodiments of the protective insulation layer 150 may have a single layer structure as illustrated in FIG. 11 or a double layer structure including a passivation layer and an organic layer of a thick thickness. Although the above exemplary embodiment discusses a single layer structure and a double layer structure, a multi-layer structure such as a triple layer structure, a fourfold layer structure or any other configuration known to one of ordinary skill in the art may also be utilized in place of or in conjunction with the single layer structure.

A contact hole C exposing the drain electrode DE is formed through the protective insulation layer 150. In one exemplary embodiment, the contact hole C is formed using an etching process. A transparent conductive layer is formed on the base substrate 101 having the contact hole C formed therethough, and the transparent conductive layer is patterned to form a third conductive pattern including a pixel electrode PE. Exemplary embodiments of the transparent conductive layer may include an optically transparent and electrically conductive material such as ITO, IZO, and other materials having similar characteristics.

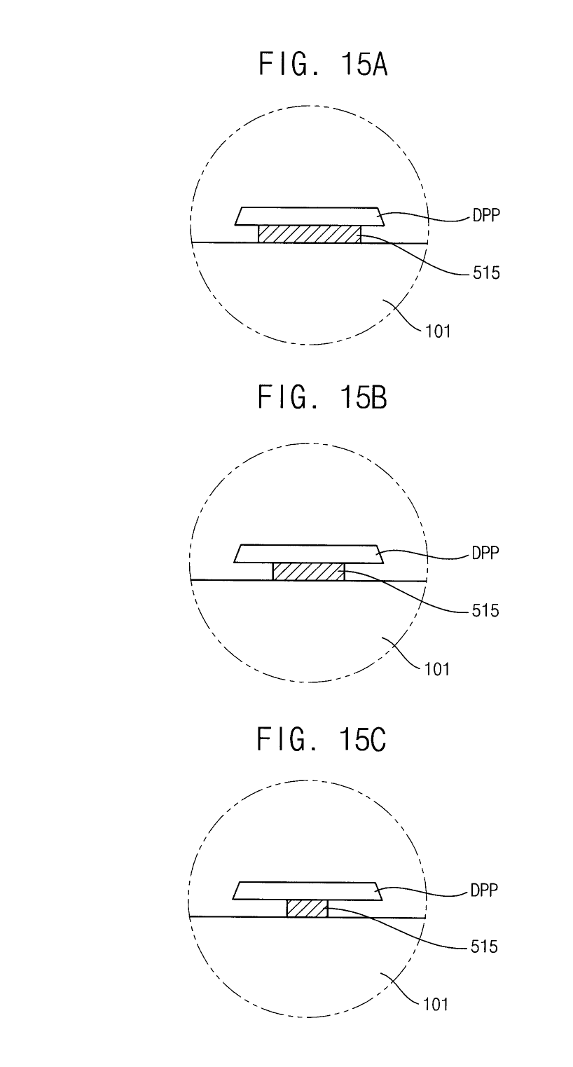

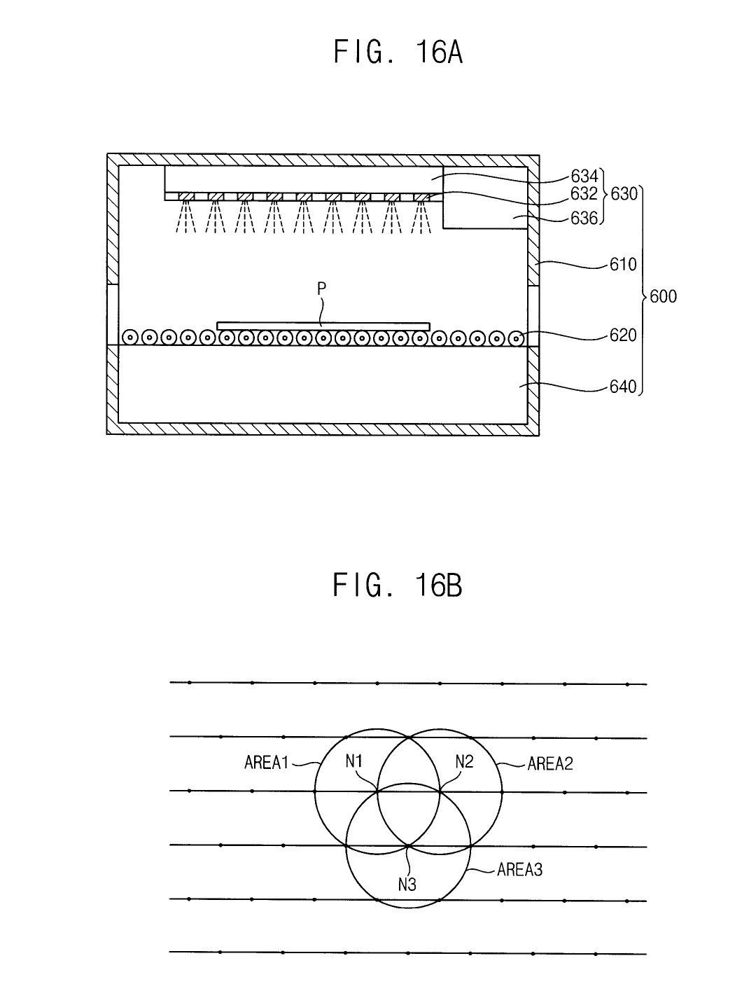

FIGS. 15A to 15C are cross-sectional schematic views illustrating a variation of cut dimension (“CD”) skew of the dummy photoresist pattern DPP and the gate metal layer positioned below the dummy photoresist pattern DPP in accordance with a time during an exemplary embodiment of a manufacturing process of the fifth exemplary embodiment of a display substrate.

Referring to FIGS. 15A to 15C, a line width of the dummy photoresist pattern DPP is about 9 μm. A CD skew is a distance between an end portion of the dummy photoresist and an end portion of the remaining gate metal layer. In the fifth exemplary embodiment of the present invention, a tapered angle is a slope when viewed at a side surface of an etched metal layer. In one exemplary embodiment, the tapered angle may be about 80 degrees to about 90 degrees.

When an etching of the dummy metal layer 515 is performed by about 50%, shapes of the dummy photoresist pattern DPP and the dummy metal layer 515 resemble that shown in FIG. 15A. Here, a CD skew between the dummy photoresist pattern DPP and the dummy metal layer 515 may be about 4.3 μm.

When an etching of the dummy metal layer 515 is performed by about 70%, shapes of the dummy photoresist pattern DPP and the dummy metal layer 515 resemble that shown in FIG. 15B. Here, a CD skew between the dummy photoresist pattern DPP and the dummy metal layer 515 may be about 5.7 μm.

When an etching of the dummy metal layer 515 is performed by about 90%, shapes of the dummy photoresist pattern DPP and the dummy metal layer 515 resemble that shown in FIG. 15C. Here, a CD skew between the dummy photoresist pattern DPP and the dummy metal layer 515 may be about 7.5 μm.

That is, as an etching process is performed, as a CD skew that is a distance between an end portion of the dummy photoresist pattern DPP and an end portion of the remaining gate metal layer is increased, so that it is recognized that a size of the dummy metal layer 515 is decreased.

The present measurement is performed when a line width of the dummy photoresist pattern DPP is about 9 mm. However, eventhough an etching process is performed about 50% when the line width of the dummy photoresist pattern DPP is about 4 μm, the CD skew may be greater than about 4.3 μm, that is, a greater value than 0.4 μm which is a reference value. Thus, when the gate line GL, the gate electrode GE and the storage line STL are formed, the dummy metal layer 515 disposed below the dummy photoresist pattern DPP may be simultaneously removed. Here, the reference value of the CD skew may be a value such that all of the dummy metal layer 515 will be removed when an etching process is performed by about 50%.

Therefore, a tapered angle of the dummy metal layer 515 is maintained about 80 degrees to about 90 degrees, so that defects such as a nonplanarization during a subsequent process of a gate patterning and a generation of a stepped difference may be prevented.

In the exemplary embodiment of a manufacturing process of the fifth exemplary embodiment of the present invention, in order to prevent a bend of a display substrate, a deformation preventing layer may further be deposited in accordance with any of the previous exemplary embodiments of the present invention.

### Exemplary Embodiment 6

A cross-sectional schematic view of the sixth exemplary embodiment of a display substrate according to the present invention is substantially the same as that of the display substrate according to the fifth exemplary embodiment illustrated in FIG. 11, and thus, a detailed description thereof will be omitted.

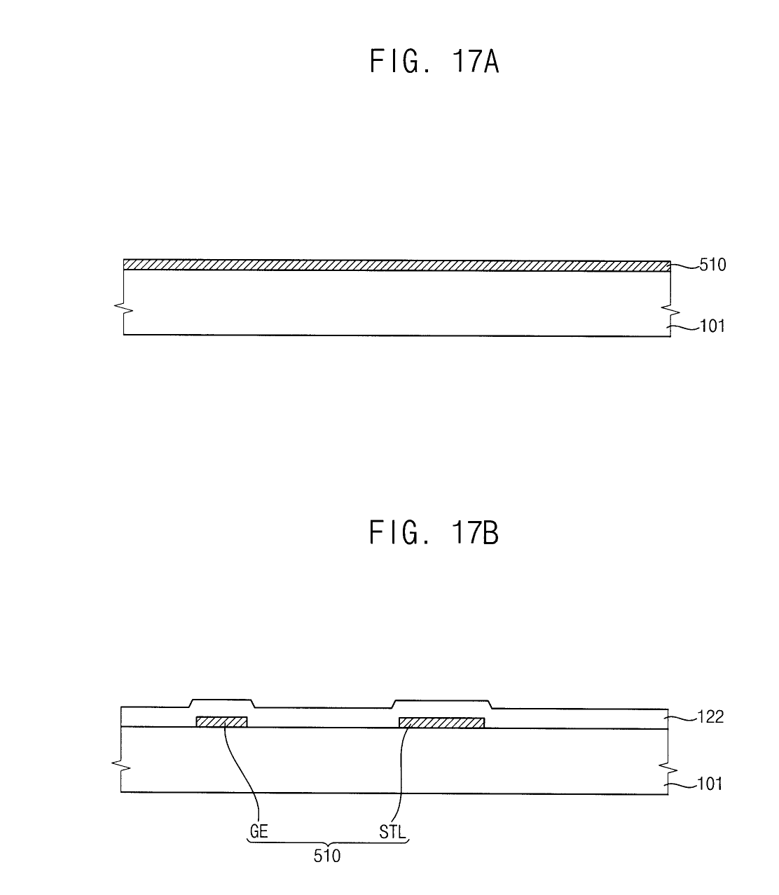

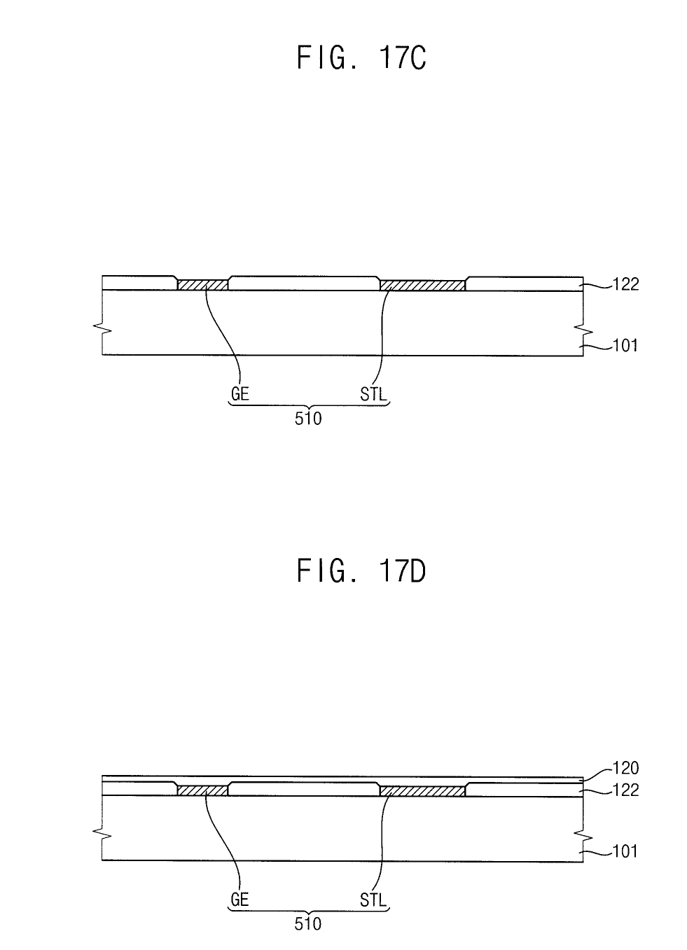

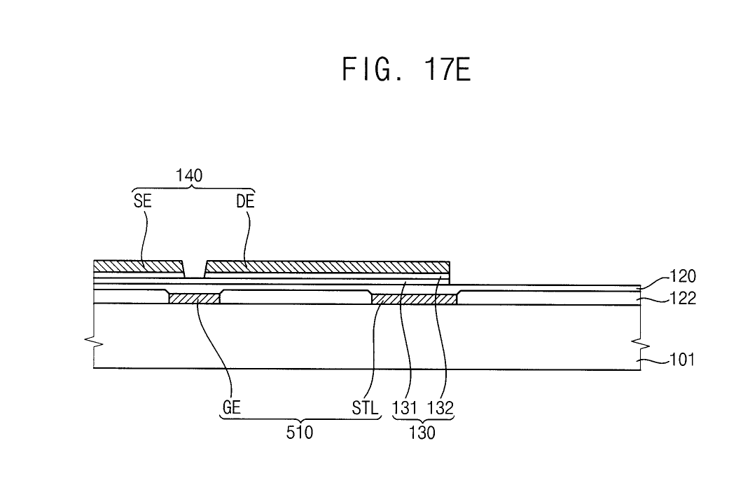

FIG. 16A is a cross-sectional schematic view illustrating an etching apparatus for manufacturing a fifth exemplary embodiment of a display substrate. FIG. 16B is a top plan view illustrating a position of nozzles of the exemplary embodiment of an etching apparatus and areas of an etching solution which is sprayed from the nozzles. FIGS. 17A to 17E are cross-sectional schematic views illustrating an exemplary embodiment of a manufacturing process of the sixth exemplary embodiment of a display substrate.

The sixth exemplary embodiment of a display substrate is substantially the same as the first exemplary embodiment of a display substrate, and any further explanation concerning the above elements will be omitted. Moreover, the sixth exemplary embodiment of a display substrate is substantially the same as the display substrate illustrated in FIG. 11 except that an etching solution is sprayed by the etching device of FIG. 16A during a manufacturing process. Thus, identical reference numerals are used in the sixth exemplary embodiment to refer to components that are the same or like those shown in FIG. 11, and thus, a detailed description thereof will be omitted.

Referring to FIGS. 16A and 16B, the etching device 600 includes a chamber 610, a transferring unit 620, a chemical providing unit 630 and an exhaust part 640. The chamber 610, the transferring unit 620, the chemical providing unit 630 and the exhaust part 640 may include a cylinder, a pipe, a motor, a valve, a pump, and various other associated components.

The chamber 610 receives a display substrate P through the transferring unit 620, and defines a space selectively wet-etching a gate metal layer 510 formed on the display substrate P using a chemical solution.

In the present exemplary embodiment, the transferring unit 620 is a conveyor including a plurality of rollers driven by a plurality of motors. The transferring unit 620 is disposed in a lower portion of an interior of the chamber 610 to support the display substrate P. The transferring unit 620 transfers the display substrate P in an interior of the chamber 610, and then the transferring unit 620 drives the display substrate P back-and-forth within the chamber 610 during an etching process in which a gate metal layer 510 of the display substrate P is etched using an etching chemical solution. Due to the back-and-forth driving, an etching solution may be uniformly sprayed at a surface of the display substrate P having a large scale size within the chamber 610.

The chemical providing unit 630 is disposed above the display substrate P that is supported by the transferring unit 620 within the chamber 610. The chemical providing unit 630 includes a main pipe 636 receiving a chemical solution from a plurality of chemical containers (not shown) that may be disposed on an exterior side of the chamber 610, a plurality of sub-pipes 634 branched from the main pipe 636 and a plurality of valves (not shown) disposed between the main pipe 636 and the sub-pipe 634. A plurality of spraying nozzles 632 which spray the etching solution to a surface of the substrate is formed along each of the sub-pipes 636. In one exemplary embodiment, the spraying nozzles 632 are formed at an end of the sub-pipes 636, respectively.

Moreover, exemplary embodiments include configurations wherein the chemical providing unit 630 may further include a plurality of sub-pumps (not shown) which provides the main pipe and sub-pipes 634 with the chemical solution. In the present exemplary embodiment, the exhaust part 640 is disposed at a lower portion of the chamber 610 to exhaust an etching remaining substance of the display substrate and a remaining chemical solution to an out side of the chamber 610.

Referring to FIG. 16B, each of the nozzles 632 sprays an etching solution on the display substrate P. In one exemplary embodiment, the nozzles 632 are disposed to overlap with each other.

In one exemplary embodiment, an etching solution sprayed from a first nozzle N1 is sprayed on the first display substrate P in a first area ‘Area1’. An etching solution sprayed from a second nozzle N2 is sprayed on the display substrate P in a second area ‘Area2’. An etching solution N3 sprayed from a third nozzle N3 is sprayed on the display substrate P in a third area ‘Area3’.

That is, an etching solution may be sprayed on a whole area of the display substrate P without an empty space due to the first to third nozzles N1, N2 and N3.

In one exemplary embodiment, a distance between the first and second nozzles N1 and N2 that are adjacent to each other, a distance between the second and third nozzles N2 and N3 that are adjacent to each other and a distance between the third and first nozzles N3 and N1 may be about 0 mm to about 60 mm, respectively.

In one exemplary embodiment, a distance between the first nozzle N1 and the second nozzle N2, a distance between the second nozzle N2 and the third nozzle N3 and a distance between the third nozzle N3 and the first nozzle N1 may be equal to each other. That is, in one exemplary embodiment, the first nozzle N1, the second nozzle N2 and the third nozzle N3 may be disposed in a regular triangle shape.

Moreover, in one exemplary embodiment, a radius of the first to third areas Area1, Area2 and Area3 may be about 35 mm to about 60 mm.

According to the sixth exemplary embodiment of the present invention, an etching solution may be uniformly sprayed on a whole area of the display substrate P, so that defects such as a nonplanarization at the subsequent process of a gate patterning and a generation of a stepped difference may be prevented eventhough the gate metal layer 510 is formed to have a thick thickness.

Referring to FIG. 17A, a gate metal layer 510 is deposited on an upper surface of the base substrate 101, e.g., through a CVD process, a sputtering process or other similar process. Alternative exemplary embodiments include configurations wherein the gate metal layer 510 may be deposited on the upper surface of the base substrate 101 through various coating techniques such as a coating process, an inkjet process, a gravia coating process, or other similar processes.

In one exemplary embodiment, an adhesive layer (not shown) may be formed between the gate metal layer 510 and the base substrate 101. Exemplary embodiments of the adhesive layer may include molybdenum (Mo), titanium (Ti), molybdenum titanium (MoTi), copper oxide (CuO), molybdenum niobium (MoNb), cabalt (Co), nickel (Ni), aluminum (Al), tantalum (Ta) and other materials having similar characteristics.

A photoresist layer is formed on the gate metal layer 110, and then the photoresist layer is partially exposed. Here, a mask is disposed on the base substrate 101, which includes a light-blocking portion corresponding to the gate line GL, the gate electrode GE and the storage line STL that form a first conductive pattern.

Thus, a photoresist layer is remained, which corresponds to a non-exposed area due to the light-blocking portion. That is, the exposed photoresist layer is developed to form a first photoresist pattern. The gate metal layer 110 is etched using the first photoresist pattern formed on the gate metal layer 110 as an etch stop layer, so that the gate line GL, the gate electrode GE and the storage line STL that form a first conductive pattern are formed on the base substrate 101.

In the present exemplary embodiment, it is described that the first photoresist pattern is a positive type photoresist material. Alternative exemplary embodiments include configurations wherein the first photoresist pattern may be formed from a negative type photoresist material.

Referring to FIG. 17B, a planarization layer 122 is formed on the base substrate 101 on which the first conductive pattern is formed.

Referring to FIG. 17C, the planarization layer 122 corresponding to the first conductive pattern is removed.

Referring to FIG. 17D, a gate insulation layer 120 is formed on the planarization layer 122 and the first conductive pattern exposed therethrough.

Referring to FIG. 17E, a channel layer 130 including a semiconductor layer 131 and an ohmic contact layer is formed on the base substrate 101 on which the gate insulation layer 120 is formed.

A data metal layer 140 is formed on the base substrate 101 on which the channel layer 130 is formed, and the data metal layer 140 is patterned to form a second conductive pattern including a data line DL, a source electrode SE and a drain electrode DE.

In the present exemplary embodiment, the channel layer 130 and the data metal layer 140 are formed through one mask, so that the channel layer 130 is formed below the second conductive pattern. Alternative exemplary embodiments include configurations wherein the channel layer 130 and the data metal layer 140 may be formed through different mask processes to form the channel layer 130 on only the gate electrode GE.

A protective insulation layer 150 is formed on the base substrate on which the data metal layer 140 is formed. Exemplary embodiments of the protective insulation layer 150 may have a single layer structure as illustrated in FIG. 17E or a double layer structure including a passivation layer and an organic layer of a large thickness.

A contact hole C exposing the drain electrode DE is formed through the protective insulation layer 150. In one exemplary embodiment, the hole C is formed using an etching process. A transparent conductive layer is formed on the base substrate 101 having the contact hole C formed therethough, and the transparent conductive layer is patterned to form a third conductive pattern including a pixel electrode PE.

In the exemplary embodiment of a manufacturing process of the sixth exemplary embodiment of the present invention, in order to prevent a bend of a display substrate, a deformation preventing layer may further deposited in accordance with any of the previous exemplary embodiments of the present invention.

Moreover, in an exemplary embodiment of a manufacturing process of the sixth exemplary embodiment, a dummy photoresist pattern DPP may be further formed in accordance with the fifth exemplary embodiment, which maintains a tapered angle of the gate metal layer 510 by about 80 degrees to about 90 degrees to realize a planarization of the subsequent process of a gate patterning.

According to exemplary embodiments of the present invention, materials having a compression stress and a tensile stress are deposited on a base substrate, so that the base substrate may receive a symmetric force.

Thus, the base substrate may not bend towards any side thereof Moreover, the gate metal layer of a large thickness may be manufactured, so that a resistance of a signal line may be decreased. A dual gate structure used to manufacture a large scale display substrate may be realized as a single gate structure based on the low resistance of the gate metal layer, so that an aperture ratio may be increased.

Moreover, a tapered angle of the dummy metal layer is maintained at about 80 degrees to about 90 degrees, so that defects such as a nonplanarization at the subsequent process of a gate patterning and a generation of a stepped difference may be prevented.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A display substrate comprising:
a base substrate;
a deformation preventing layer disposed on a lower surface of the base substrate, wherein the deformation preventing layer applies a force to the base substrate to prevent the base substrate from bending;
a gate line disposed on an upper surface of the base substrate;
a data line disposed on the base substrate; and
a pixel electrode disposed on the base substrate.

2. The display substrate of claim 1, wherein each of the deformation preventing layer and the gate line has a tensile stress applied thereto.

3. The display substrate of claim 2, wherein the gate line comprises at least one selected from the group consisting of aluminum, copper, silver, an aluminum alloy, a copper alloy, a silver alloy and combinations thereof.

4. The display substrate of claim 2, wherein the deformation preventing layer comprises an organic insulation layer.

5. The display substrate of claim 2, wherein the deformation preventing layer comprises an inorganic insulation layer.

6. The display substrate of claim 5, wherein the deformation preventing layer comprises at least one selected from the group consisting of a silicon nitride, silicon oxide and combinations thereof.

7. A display substrate comprising:
a base substrate;
a deformation preventing layer disposed on an upper surface of the base substrate, wherein the deformation preventing layer applies a force to the base substrate to prevent the base substrate from bending;
a gate line disposed on the deformation preventing layer;
a data line disposed on the base substrate; and
a pixel electrode disposed on the base substrate.

8. The display substrate of claim 7, wherein the gate line comprises a metal material having a tensile stress applied thereto.

9. The display substrate of claim 8, wherein the deformation preventing layer comprises a material having a compression stress applied thereto.

10. The display substrate of claim 9, wherein the deformation preventing layer comprises an inorganic layer.

11. The display substrate of claim 10, wherein the deformation preventing layer comprises at least one selected from the group consisting of silicon nitride, titanium nitride, molybdenum nitride, silicon oxide, copper oxide, copper nitride, indium tin oxide, indium zinc oxide, and combinations thereof

12. The display substrate of claim 9, wherein the deformation preventing layer comprises an organic layer.

13. A method of manufacturing a display substrate, the method comprising:
disposing a deformation preventing layer on a lower surface of a base substrate, wherein the deformation preventing layer applies a force to the base substrate to prevent the base substrate from bending;
disposing a gate metal layer on an upper surface of the base substrate;
patterning the gate metal layer to form a gate line;
disposing a data line crossing the gate line on the base substrate; and
disposing a pixel electrode on the base substrate.

14. The method of claim 13, wherein each of the deformation preventing layer and the gate line has a tensile stress applied thereto.

15. The method of claim 14, wherein the deformation preventing layer comprises at least one selected from the group consisting of aluminum, copper, silver, an aluminum alloy, a copper alloy, a silver alloy and combinations thereof.

16. The method of claim 13, wherein the patterning the gate metal layer further comprises:
removing the deformation preventing layer.

17. The method of claim 16, wherein the patterning the gate metal layer and removing the deformation preventing layer are performed substantially simultaneously by a same etching solution.

18. The method of claim 13, wherein a thickness of the gate metal layer is about 1 μm to about 10 μm.

19. The method of claim 18, wherein a thickness of the deformation preventing layer is no more than half of the thickness of the gate metal layer.

20. The method of claim 19, wherein the thickness of the deformation preventing layer is thinner than that of the gate metal layer by about 1.34 μm to about 1.36 μm.

21. The method of claim 13, further comprising forming an adhesive layer between the base substrate and the gate metal layer.

22. The method of claim 21, wherein the adhesive layer comprises at least one selected from the group consisting of molybdenum, titanium, molybdenum titanium, copper oxide, molybdenum niobium, cobalt, nickel, aluminum, tantalum and combinations thereof.

23. The method of claim 13, further comprising heating the base substrate on which the deformation preventing layer and the gate metal layer are formed.

24. The method of claim 13, wherein the deformation preventing layer comprises an organic insulation layer.

25. The method of claim 24, wherein the organic insulation layer is a film.

26. The method of claim 13, wherein the deformation preventing layer comprises an inorganic insulation layer.

27. A method of manufacturing a display substrate, the method comprising:
disposing a deformation preventing layer on an upper surface of a base substrate, wherein the deformation preventing layer applies a force to the base substrate to prevent the base substrate from bending;
disposing a gate metal layer on the deformation preventing layer;
patterning the gate metal layer to form a gate line;
disposing a data line crossing the gate line on the base substrate; and
disposing a pixel electrode on the base substrate on which the data line is formed.

28. A method of manufacturing a display substrate, the method comprising:
disposing a gate metal layer on an upper surface of a base substrate;
forming a gate line from the gate metal layer using a line photoresist pattern corresponding to a gate line and a dummy photoresist pattern;
disposing a data line crossing the gate line on the base substrate;
disposing a pixel electrode on the base substrate; and
using the dummy photoresist pattern to etch the gate line to have a tapered angle.

29. The method of claim 28, further comprising:
disposing a planarization layer on the gate line;
removing a planarization layer corresponding to the gate line by performing a rear surface exposing process with respect to the base substrate; and
disposing a gate insulation layer on the gate line and the planarization layer.

30. The method of claim 29, wherein a thickness of the gate line is substantially thicker than that of the gate insulation layer.

31. The method of claim 30, wherein the thickness of the gate line is about 0.5 μm to about 3.0 μm.

32. The method of claim 28, further comprising removing the gate metal layer corresponding to the dummy photoresist pattern when the gate line is formed.

33. The method of claim 28, wherein a line width of the dummy photoresist pattern is substantially smaller than that of the gate line.

34. The method of claim 33, wherein the line width of the dummy photoresist pattern is about 3 μm to about 4 μm.

35. The method of claim 28, wherein an interval distance between individual lines of the dummy photoresist pattern is about 3 μm to about 300 μm.

36. The method of claim 28, wherein a tapered angle of the gate line is about 80 degrees to about 90 degrees.

37. The method of claim 28, wherein at least one branch shape is repeatedly formed to form the dummy photoresist pattern.

38. The method of claim 37, wherein the branch shape comprises at least one of an I-shape, a rectangular shape, a circular shape, and a V-shape.

39. A method of manufacturing a display substrate, the method comprising:
disposing a gate metal layer on an upper surface of a base substrate;
spraying an etching solution from a nozzle on an area overlapping areas where etching solution from adjacent nozzles is sprayed;
patterning the gate metal layer using the etching solution;
disposing a data line crossing a gate line patterned from the gate metal layer; and
disposing a pixel electrode on the base substrate.

40. The method of claim 39, wherein a line photoresist pattern corresponding to the gate line and a dummy photoresist pattern including a branch shape are used during patterning the gate metal layer.

41. The method of claim 39, wherein a distance between adjacent nozzles is about 0 nm to about 60 nm.

42. The method of claim 39, wherein a radius of an area where the etching solution is sprayed is about 35 mm to about 60 mm.
